(19) United States
(12) Patent Application Publication
(10) Pub. No.: US 2022/0300120 A1
(43) Pub. Date: Sep. 22, 2022

(54) INFORMATION PROCESSING APPARATUS, AND CONTROL METHOD

(71) Applicant: SONY GROUP CORPORATION, TOKYO (JP)

(72) Inventors: MITSURU NISHIBE, TOKYO (JP); ATSUSHI ISHIHARA, TOKYO (JP); HIROYUKI AGA, TOKYO (JP); HIROTAKE ICHIKAWA, TOKYO (JP)

(21) Appl. No.: 17/636,477

(22) PCT Filed: Aug. 28, 2020
(86) PCT No.: PCT/JP2020/032723

§ 371 Date: Feb. 18, 2022

(30) Foreign Application Priority Data
Aug. 30, 2019 (JP) 2019-158864

(51) Int. Cl. G06F 3/0481; G06T 7/70; G06F 3/01; G06T 19/20

(52) U.S. Cl. CPC G06F 3/0481; G06T 7/70; G06F 3/013; G06T 19/20; G06T 2219/2016

(57) ABSTRACT

A display delay of a virtual object is to be shortened, to alleviate the user's feeling of strangeness and enhance the sense of immersion in an AR space.

An information processing apparatus according to the present technology includes: a drawing control unit that performs drawing control on a virtual object displayed while being associated with a real object recognized in an object recognition process; and a correction control unit that performs control so that an image obtained in a virtual object drawing process performed on the basis of a recognition result of an object recognition processing performed at a first time point is corrected on the basis of a recognition result of an object recognition process performed at a second time point that is later than the first time point.

### TECHNICAL FIELD

The present technology relates to the technical field of an information processing apparatus that performs control for displaying a virtual object associated with a real object recognized in an object recognition process, and a method for performing the control.

### BACKGROUND ART

The virtual reality (VR) technology for allowing a user to perceive an artificially constructed virtual space has been put into practical use. Further, an augmented reality (AR) technology developed from the VR technology has been spreading in recent years. By the AR technology, an augmented reality space (AR space) constructed by partially modifying a real space is presented to the user. For example, by the AR technology, a virtually generated object (a virtual object) is superimposed on an image supplied from an imaging device directed to the real space, and the user feels as if the virtual object exists in the real space shown in the image. Alternatively, there also is an AR technology by which an image of a virtual object is projected onto a real space by a projector device, to make the user feel as if the virtual object exists in the real space.

In a case where a 3D object as a virtual object is to be displayed while being associated with a real object, such as a case where the 3D object is to be superimposed and displayed on the real object, or a case where the 3D object is to be displayed while maintaining a predetermined positional relationship with the real object, the position and the posture of the real object are recognized, and the 3D object is drawn as a two-dimensional image so that the 3D object is displayed in the position and posture corresponding to the recognized position and posture.

However, drawing a 3D object takes a long time in some cases. If the user's head moves and causes a change in the position of the viewpoint before a drawn object is displayed to the user, for example, a relative difference is caused between the position of the viewpoint and the position at which the drawn object is displayed. The user recognizes such a difference as a delay of the object following displacement of the real object. That is, the difference is recognized as a display delay of the object.

To cope with such a display delay caused by movement of the head, it is effective to correct the drawn image of the object on the basis of detection information about the position and posture of the head (detection information about the viewpoint position and the line-of-sight direction) (see Patent Document 1 listed below, for example). Specifically, the amount of change in the position and the posture of the head during the period from the start time point till the end time point of the drawing is determined from information about the position and the posture of the head repeatedly detected in predetermined cycles, for example, and image correction for changing the position and the posture of the object after the drawing is performed on the basis of the amount of change.

Thus, the occurrence of a display delay of the object due to the time required for the drawing can be prevented.

### CITATION LIST

### Patent Document

Patent Document 1: Japanese Patent Application Laid-Open No. 2018-106157

### SUMMARY OF THE INVENTION

### Problems to be Solved by the Invention

However, in the AR technology, a display delay of a 3D object is not caused only by a change in the position and the posture of a display device. For example, in a case where the target real object is a moving object, a display delay might be caused by movement of the real object.

The present technology has been made in view of the above circumstances, and aims to alleviate the user's feeling of strangeness and enhance the sense of immersion in an AR space by shortening a display delay of a virtual object.

### Solutions to Problems

An information processing apparatus according to the present technology includes: an image recognition processing unit that performs, on the basis of a captured image including a real object, a first recognition process related to the position and the posture of the real object at a first time point, and a second recognition process related to the position and the posture of the real object at a second time point that is later than the first time point; a drawing control unit that controls a drawing processing unit to perform a first drawing process for a related virtual object associated with the real object on the basis of the first recognition process, and a second drawing process for the related virtual object associated with the real object on the basis of the second recognition process; and a correction control unit that corrects a virtual object image that is an image of the related virtual object obtained upon completion of the first drawing process, on the basis of a result of the second recognition process before completion of the second drawing process.

As image correction is performed on the related virtual object on the basis of results of recognition of the position and the posture of the real object as described above, the position and the posture of the related virtual object can be changed in accordance with a change in the position and the posture of the real object in a case where such a change occurs. Further, in the configuration described above, when the latest recognition result (the recognition result of the second recognition process) is obtained, the image of the related virtual object can be instantly output as the image obtained by correcting the image that is obtained in the drawing process (the first drawing process) based on the past recognition results, without a wait for completion of the drawing process (the second drawing process) based on the latest recognition result.

In the above information processing apparatus according to the present technology, the correction control unit may perform correction to change the position of the related virtual object in a vertical and horizontal plane in the virtual object image, on the basis of information about the position of the real object recognized in the vertical and horizontal plane by the image recognition processing unit.

With this arrangement, in a case where the real object moves in the vertical and horizontal plane, image correction can be performed to change the position of the related virtual object in the vertical and horizontal plane in accordance with the movement.

In the above information processing apparatus according to the present technology, the correction control unit may perform the correction to change the size of the related virtual object in the virtual object image, on the basis of information about the position of the real object recognized in the depth direction by the image recognition processing unit.

With this arrangement, in a case where the real object moves in the depth direction, it is possible to change the size of the related virtual object in accordance with the position of the real object in the depth direction, by enlarging the image of the related virtual object when the real object approaches the viewpoint of the user, by making the image of the related virtual object smaller when the real object moves away from the viewpoint of the user, or the like, for example.

In the above information processing apparatus according to the present technology, the correction control unit may perform the correction to change the position or the posture of the related virtual object in accordance with a change in the viewpoint position or the line-of-sight direction of the user.

With this arrangement, it is possible to shorten the display delay to be caused by a change in the viewpoint position and the line-of-sight direction when the user moves the head or the like.

In the above information processing apparatus according to the present technology, in a case where one or a plurality of related virtual objects to be subjected to the correction is selected from a plurality of related virtual objects each associated with a different real object, the correction control unit may preferentially select a related virtual object associated with the real object having large movement.

With this arrangement, it is possible to prevent image correction from being performed inadvertently on a virtual object associated with a real object having small movement or no movement.

In the above information processing apparatus according to the present technology, a processing cycle of the correction may be shorter than a processing cycle of the image recognition processing unit.

With this arrangement, it is possible to shorten the delay time from the point of time when a result of recognition of the real object is obtained until the image correction for the virtual object is started.

In the above information processing apparatus according to the present technology, the drawing control unit may control the drawing processing unit to draw the related virtual object and a non-related virtual object in different drawing planes of a plurality of drawing planes, the non-related virtual object being a virtual object independent of an image recognition process for the real object.

With this arrangement, it is possible to perform appropriate image correction depending on whether or not the virtual object is a related virtual object, such as performing image correction on a non-related virtual object in accordance with the viewpoint position and the line-of-sight direction of the user, and performing image correction on a related virtual object in accordance with the position and the posture of the associated real object and the viewpoint position and the line-of-sight direction.

In the above information processing apparatus according to the present technology, when the number of the related virtual objects is equal to or larger than the number of drawing planes in the plurality of drawing planes, and the number of drawing planes in the plurality of drawing planes is n (n being a natural number), the drawing control unit may control the drawing processing unit to select (n−1) of the related virtual objects, draw the selected related virtual objects exclusively in at least one drawing plane, and draw the unselected related virtual objects and the non-related virtual objects in a remaining one drawing plane.

With this arrangement, in a case where virtual objects include a non-related virtual object for which image correction based on an object recognition result is unnecessary, and the number of related virtual objects is equal to or larger than n while the number of drawing planes is n, it is possible to perform image correction based on a result of recognition of associated real objects Ro for the (n−1) related virtual objects, and perform image correction in accordance with the viewpoint position and the line-of-sight direction of the user for the remaining related virtual objects as well as the non-related virtual objects. That is, in a case where image correction based on a result of recognition of real objects cannot be performed for all the related virtual objects because of the relationship between the number of drawing planes and the number of related virtual objects, image correction based on a result of recognition of the real objects is preferentially performed for the (n−1) related virtual objects.

In the above information processing apparatus according to the present technology, the drawing control unit may perform the selection, using a selection criterion by which the possibility of selection increases with increase in the amount of movement of the real object.

With this arrangement, related virtual objects each having a large amount of movement and a high possibility of a display delay to be sensed can be preferentially selected as the targets of image correction based on a result of recognition of real objects.

In the above information processing apparatus according to the present technology, the drawing control unit may perform the selection, using a selection criterion by which the possibility of selection increases with decrease in the area of the real object.

In a case where a related virtual object is superimposed and displayed on a real object, when the area of the real object is large even though the amount of movement of the real object is large, the ratio of the area of the position error occurrence portion of the related virtual object to the area of the real object might be small. In such a case, any display delay is hardly sensed. On the other hand, in a case where the area of the real object is small even though the amount of movement of the real object is small, the ratio might be large, and in such a case, the display delay is easily perceived.

In the above information processing apparatus according to the present technology, the drawing control unit may perform the selection, using a selection criterion by which the possibility of selection increases with decrease in the distance between the user's point of gaze and the real object.

With this arrangement, related virtual objects that are displayed near the user's point of gaze and have a high possibility of a display delay to be sensed can be preferentially selected as the targets of image correction based on a result of recognition of real objects.

In the above information processing apparatus according to the present technology, the drawing control unit may control the drawing processing unit so that the update frequency of a drawing plane for drawing a non-related virtual object independent of an image recognition process for the real object among the plurality of drawing planes becomes lower than the update frequency of a drawing plane for drawing the related virtual object.

With this arrangement, drawing in all the drawing planes at a high update frequency can be prevented.

In the above information processing apparatus according to the present technology, in a case where the related virtual object is a related virtual object that has an animation, the drawing control unit may control the drawing processing unit so that the drawing update frequency of the related virtual object becomes lower than the drawing update frequency of a related virtual object not having an animation.

With this arrangement, in a case where a plurality of drawing planes needs be used, if the related virtual object to be drawn does not have an animation, drawing of the related virtual object is performed at a low update frequency. If the related virtual object has an animation, drawing of the related virtual object is performed at a high update frequency.

In the above information processing apparatus according to the present technology, in a case where a drawing process is performed in a plurality of drawing planes, the drawing control unit may control the drawing processing unit to use at least one drawing plane smaller in size than any other drawing plane.

With this arrangement, the processing load of the drawing process can be reduced in a case where a plurality of drawing planes needs to be used.

In the above information processing apparatus according to the present technology, when part of the user's body overlaps a virtual object as viewed from the viewpoint position of the user, the correction control unit may perform the correction on a shielding virtual object that is a virtual object that shields the overlapping portion of the virtual object.

With this arrangement, the display delay of the shielding virtual object can be shortened.

In the above information processing apparatus according to the present technology, the shielding virtual object may be a virtual object in the form of a hand of the user.

With this arrangement, the display delay of the shielding virtual object in the form of a hand of the user can be shortened.

In the above information processing apparatus according to the present technology, the drawing control unit may control the drawing processing unit to use at least one drawing plane exclusively for the shielding virtual object, the at least one drawing plane being of the plurality of drawing planes that can be used by the drawing processing unit.

With this arrangement, image correction based on an object recognition result regarding the shielding virtual object can be preferentially performed.

The above information processing apparatus according to the present technology may further include a virtual shadow image generation unit that generates, on the basis of a result of the first recognition process before completion of the first drawing process, a light source viewpoint image that is an image of the related virtual object as viewed from the position of a virtual light source that illuminates the related virtual object, performs control to correct the generated light source viewpoint image on the basis of a result of the second recognition process before completion of the second drawing process, and generates, on the basis of the corrected light source viewpoint image, a virtual shadow image that is an image of a virtual shadow of the related virtual object.

With this arrangement, regarding the light source viewpoint image to be used for generating a virtual shadow image, the image generated on the basis of the past recognition result (the result of the first recognition process) can be immediately corrected and used on the basis of the latest recognition result (the result of the second recognition process) even in a case where the target real object moves. Accordingly, in a case where the realistic feeling is to be increased by displaying a shadow (a virtual shadow) of the related virtual object, the display delay of the shadow can be shortened.

In the above information processing apparatus according to the present technology, on the basis of the result of the first recognition process before completion of the first drawing process, the virtual shadow image generation unit may calculate a drawing-side distance to the light source that is a distance from each point in a three-dimensional space projected onto respective pixels of a drawing image obtained by the drawing processing unit to the virtual light source, and the virtual shadow image generation unit may also generate the light source viewpoint image that is a depth image as a shadow map formed by a shadow map method, perform correction on the light source viewpoint image by performing a process of changing the position or the size of the image area of the related virtual object in the shadow map on the basis of the result of the second recognition process, and generate a virtual shadow image on the basis of the corrected shadow map and the drawing-side distance to the light source.

That is, in generating the virtual shadow image by the shadow map method, correction is performed so that the position or the size of the image area of the real object in the shadow map generated on the basis of the result of the first recognition process is changed on the basis of the latest object recognition result (the result of the second recognition process).

Further, a control method according to the present technology is a control method that includes: performing a first recognition process related to the position and the posture of a real object at a first time point, on the basis of a captured image including the real object; controlling a drawing processing unit to perform a first drawing process for a related virtual object associated with the real object on the basis of the first recognition process; performing a second recognition process related to the position and the posture of the real object on the basis of a captured image including the real object at a second time point that is later than the first time point; controlling the drawing processing unit to perform a second drawing process for the related virtual object associated with the real object on the basis of the second recognition process; and, before the second drawing process is completed, correcting a first image of the related virtual object obtained upon completion of the first drawing process, on the basis of a result of the second recognition process.

By such a control method, it is also possible to achieve effects similar to those of the information processing apparatus according to the present technology described above.

### BRIEF DESCRIPTION OF DRAWINGS

FIG. 1 is a diagram showing an example configuration of an AR system including an information processing apparatus as an embodiment.

FIG. 2 is a diagram showing an example external configuration of the information processing apparatus as an embodiment.

FIG. 3 is a block diagram showing an example internal configuration of the information processing apparatus as an embodiment.

FIG. 4 is a diagram for explaining the functions of the information processing apparatus as an embodiment.

FIG. 5 is a diagram for explaining a delay accompanying drawing of a virtual object.

FIG. 6 is a diagram for explaining a delay shortening method as an embodiment.

FIG. 7 is a diagram for explaining an example of image correction based on an object recognition result.

FIG. 8 is a diagram for explaining image correction based on sensor signals.

FIG. 9 is a diagram for explaining an example of an image correction pattern based on sensor signals.

FIG. 10 is a diagram for explaining image correction after a plurality of virtual objects is drawn with different drawing planes.

FIG. 11 is a flowchart showing processes compatible with a drawing control unit according to the embodiment.

FIG. 12 is a flowchart showing a process for performing first correction control in the embodiment.

FIG. 13 is a flowchart showing a process for performing second correction control in the embodiment.

FIG. 14 is a diagram for explaining phase adjustment of the processing timings between the side of the recognition process and the side of the output process.

FIG. 15 is a diagram for explaining another example of reduction of the drawing processing load.

FIG. 16 is a diagram showing an example in which another virtual object Vo is shielded by a shielding virtual object.

FIG. 17 is a diagram for explaining the problems in a case where image correction based on an object recognition result is applied to a virtual shadow image.

FIG. 18 is a block diagram showing an example internal configuration of an information processing apparatus for shortening a display delay of a virtual shadow.

FIG. 19 is a diagram for explaining a shadow map method.

FIG. 20 is a diagram for explaining a shadow range.

FIG. 21 is a diagram for explaining image correction to be performed on a light source viewpoint image.

FIG. 22 is a timing chart showing a flow of processes related to the image correction of the light source viewpoint image and image correction of a virtual object.

FIG. 23 is a diagram for explaining the relationship between the image correction of the light source viewpoint image and the corresponding pixels in a drawing image mapped onto the respective pixels of the light source viewpoint image in a shadow map.

FIG. 24 is a flowchart showing an example of specific processing procedures to be carried out to implement a shadow display method as an embodiment.

### MODE FOR CARRYING OUT THE INVENTION

Embodiments according to the present technology will be described below in the following order, with reference to the accompanying drawings.

<1. Configuration of an AR system as an embodiment>

(1-1. System configuration)

(1-2. Example internal configuration of an information processing apparatus)

<2. Delay accompanying drawing of a virtual object>

<3. Delay shortening method as an embodiment>

<4. Processing procedures>

<5. Another example of reduction of the drawing processing load>

<6. Shielding virtual object>

<7. Shadow display>

<8. Modifications>

<9. Program and a storage medium>

<10. Summary of the embodiments>

<11. Present technology>

### 1. Configuration of an AR System as an Embodiment

### 1-1. System Configuration

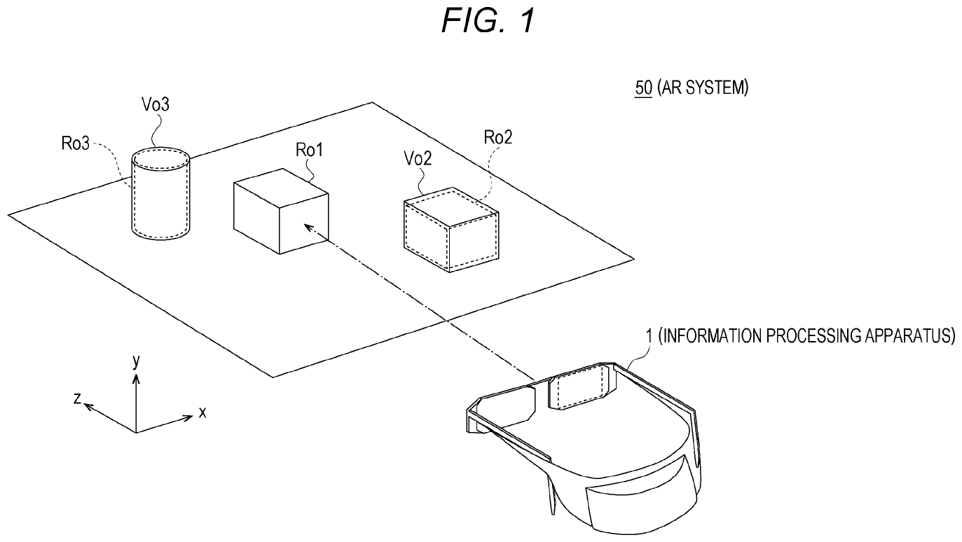

FIG. 1 is a diagram showing an example configuration of an augmented reality (AR) system 50 including an information processing apparatus 1 as an embodiment. As shown in the drawing, the AR system 50 as an embodiment includes at least the information processing apparatus 1.

Here, FIG. 1 shows real objects Ro1, Ro2, and Ro3 as examples of a real object Ro placed in a real space. In the AR system 50 of this example, a virtual object Vo is placed so as to be superimposed on a predetermined real object Ro among these real objects Ro by an AR technology, and is displayed to the user. In the present disclosure, a virtual object Vo that is superimposed on a real space on the basis of an image recognition result regarding a real object Ro is sometimes referred to as a “related virtual object”. In the example shown in the drawing, a virtual object Vo2 is superimposed on the real object Ro2, and a virtual object Vo3 is superimposed on the real object Ro3. Specifically, the virtual objects Vo are displayed so that the positions of the virtual objects Vo substantially match the positions of the real objects Ro when viewed from the user's viewpoint. Note that the present technology is not limited to the technology by which the virtual objects Vo are superimposed on the real objects Ro. The virtual objects Vo are only required to be superimposed on positions associated with the positions of the real objects Vo, and may be superimposed on the real space so as to fix the relative distances while being separated from the real objects Ro, for example.

A position in the real space is defined by the values of three axes: the x-axis corresponding to the horizontal axis, the y-axis corresponding to the vertical axis, and the z-axis corresponding to the depth axis.

The information processing apparatus 1 acquires information for recognizing the real objects Ro, recognizes the positions of the real objects Ro in the real space, and, on the basis of the result of the recognition, displays the virtual objects Vo superimposed on the real objects Ro to the user.

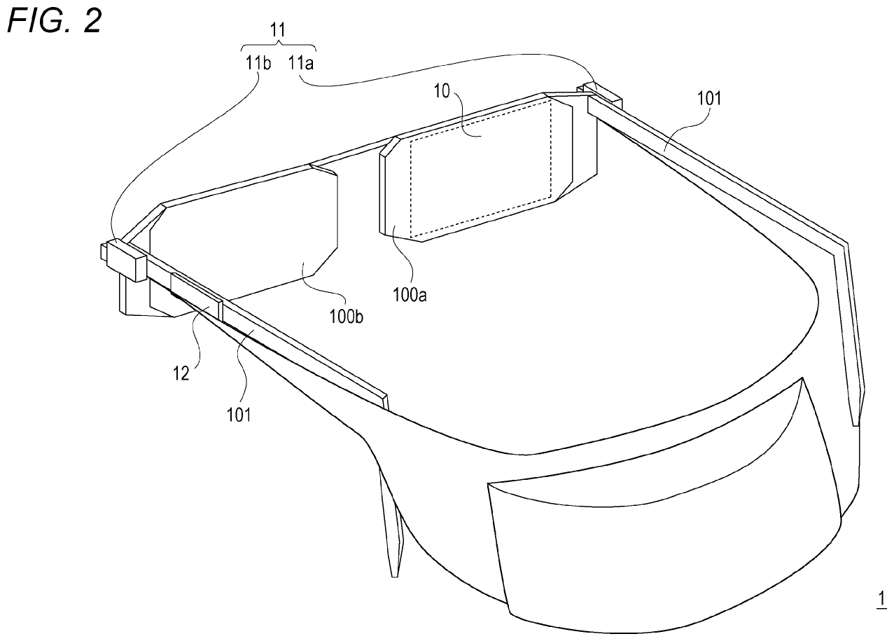

FIG. 2 is a diagram showing an example external configuration of the information processing apparatus 1. The information processing apparatus 1 in this example is formed as a so-called head-mounted device that is used when being worn on at least part of the head of the user. For example, in the example shown in FIG. 2, the information processing apparatus 1 is formed as a so-called eyewear-like (glasses-like) device, and at least one of lenses 100a and 100b is formed as a transmissive display 10. The information processing apparatus 1 also includes a first imaging unit 11a and a second imaging unit 11b as an imaging unit 11, and an operating unit 12 and a holding unit 101 corresponding to the frame of eyewear. When the information processing apparatus 1 is worn on the head of the user, the holding unit 101 holds the display 10, the first imaging unit 11a and the second imaging unit 11b, and the operating unit 12 so as to maintain a predetermined positional relationship with the head of the user. Further, although not shown in FIG. 2, the information processing apparatus 1 may include a sound collection unit for collecting user's voice and the like.

In the example shown in FIG. 2, the lens 100a corresponds to the lens on the side of the right eye, and the lens 100b corresponds to the lens on the side of the left eye. In a case where the information processing apparatus 1 is worn by the user, the holding unit 101 holds the display 10 so that the display 10 is positioned in front of the eye(s) of the user.

The first imaging unit 11a and the second imaging unit 11b are formed as so-called stereo cameras, and are held by the holding unit 101 so as to face substantially the same direction as the line-of-sight direction of the user when the information processing apparatus 1 is worn on the head of the user. At this point of time, the first imaging unit 11a is held in the vicinity of the right eye of the user, and the second imaging unit 11b is held in the vicinity of the left eye of the user. On the basis of such a configuration, the first imaging unit 11a and the second imaging unit 11b capture images of an object located on the front side of the information processing apparatus 1 (the side of the user's line-of-sight direction), or more particularly, capture images of a real object Ro located in the real space from different positions. As a result, the information processing apparatus 1 acquires images of the object located on the front side of the user, and can calculate the distance to the object on the basis of the disparity between the images captured by the first imaging unit 11a and the second imaging unit 11b. Note that the starting point for measuring the distance to the object is only required to be set as a position that can be regarded as the viewpoint position of the user, or a position near the viewpoint position of the user, such as the position of the first imaging unit 11a or the second imaging unit 11b, for example.

Note that the method for measuring the distance to the object is not necessarily the stereo method using the first imaging unit 11a and the second imaging unit 11b described above. As a specific example, distance measurement can be performed on the basis of a method such as “motion parallax”, “time of flight (ToF)”, or “structured light”. Here, “ToF” is a method by which light such as infrared rays is emitted onto the object, the time until the emitted light is reflected by the object and returns is measured for each pixel, and an image (a so-called distance image) including the distance (depth) to the object is obtained on the basis of the result of the measurement. Further, “structured light” is a method by which a pattern formed with light such as infrared rays is emitted onto the object, the object is imaged, and a distance image including the distance (depth) to the object is obtained on the basis of the change in the pattern obtained from the result of the imaging. Meanwhile, “motion parallax” is a method for measuring the distance to the object on the basis of disparity even with a monocular camera. Specifically, a camera is moved to capture images of the object from different viewpoints, and the distance to the object is measured on the basis of the parallax between the captures images. Note that, at this point of time, the moving distance and the moving direction of the camera are recognized by various kinds of sensors, so that the distance to the object can be measured more accurately. Note that components (such as a monocular camera or a stereo camera, for example) of the imaging unit may be changed depending on the distance measurement method.

The operating unit 12 is a component for receiving an operation on the information processing apparatus 1 from the user. The operating unit 12 may be formed with an input device such as a touch screen or a button, for example. The operating unit 12 is held at a predetermined position in the information processing apparatus 1 by the holding unit 101. For example, in the example shown in FIG. 2, the operating unit 12 is held at the position corresponding to a temple of glasses.

The information processing apparatus 1 shown in FIG. 2 corresponds to an example of a see-through head-mounted display (HMD). A see-through HMD uses a semitransparent mirror or a transparent light guide plate, for example, to hold a virtual image optical system including a transparent light guide unit or the like in front of the user's eyes and display an image on the inner side of the virtual image optical system. Accordingly, the user wearing the see-through HMD can view the outside scenery while viewing the image displayed on the inner side of the virtual image optical system. With such a configuration, the see-through HMD can superimpose an image of a virtual object on an optical image of a real object located in the real space, on the basis of an AR technology, for example.

### 1-2. Example Internal Configuration of the Information Processing Apparatus

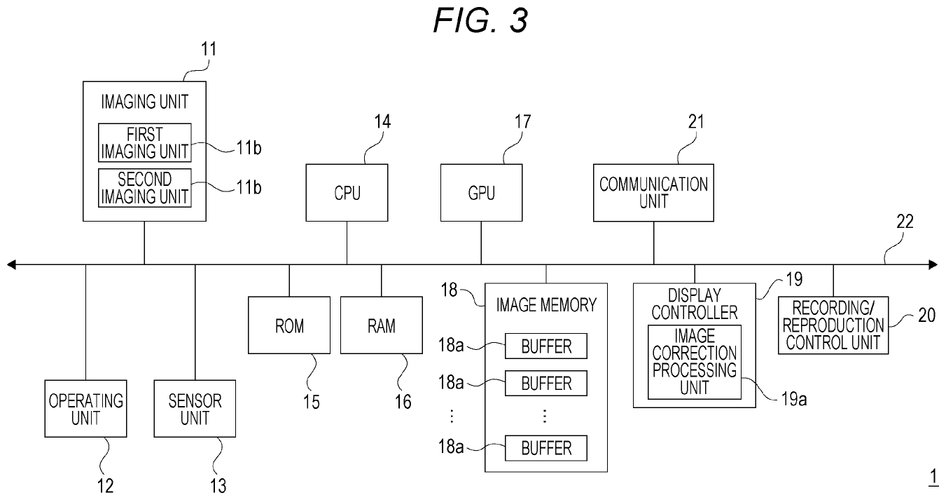

FIG. 3 is a block diagram showing an example internal configuration of the information processing apparatus 1. As shown in the drawing, the information processing apparatus 1 includes the display 10, the imaging unit 11, and the operating unit 12 described above, and also includes a sensor unit 13, a central processing unit (CPU) 14, a read only memory (ROM) 15, a random access memory (RAM) 16, a graphics processing unit (GPU) 17, an image memory 18, a display controller 19, a recording/reproduction control unit 20, a communication unit 21, and a bus 22. As shown in the drawing, the respective components of the imaging unit 11, the operating unit 12, the sensor unit 13, the CPU 14, the ROM 15, the RAM 16, the GPU 17, the image memory 18, the display controller 19, the recording/reproduction control unit 20, and the communication unit 21 are connected via the bus 22, and can perform data communication with one another via the bus 22.

The sensor unit 13 comprehensively indicates the sensors for detecting the position (a position in the real space) and movement of the information processing apparatus 1 depending on the movement of the head of the user wearing the information processing apparatus 1. Specifically, the sensor unit 13 in this example includes an acceleration sensor and an angular velocity sensor (a gyroscope sensor). The acceleration sensor is a three-axis acceleration sensor, and the angular velocity sensor is a sensor designed to be capable of detecting components in the yaw direction, the pitch direction, and the roll direction. With this arrangement, changes in the position and posture of the information processing apparatus 1 can be detected.

Here, the position of the information processing apparatus 1 detected on the basis of a detection signal of the sensor unit 13 (this signal will be hereinafter also referred to as a “sensor signal”) can be regarded as the viewpoint position of the user. Also, the posture (orientation) of the information processing apparatus 1 detected on the basis of a detection signal of the sensor unit 13 can be regarded as the line-of-sight direction of the user. In this sense, in the description below, detection of the position of the information processing apparatus 1 based on a sensor signal will be referred to as “detection of the viewpoint position”, and further, detection of the posture of the information processing apparatus 1 based on a sensor signal will be referred to as “detection of the line-of-sight direction”.

The CPU 14 performs various kinds of processing according to a program stored in the ROM 15 or a program loaded into the RAM 16. The RAM 16 also stores data and the like necessary for the CPU 14 to perform various kinds of processing, as appropriate.

The GPU 17 performs a process of drawing a virtual object Vo as a three-dimensional (3D) object. At the time of this drawing, the image memory 18 is used. Specifically, a plurality of buffers (buffer areas) 18a to be used as image frame buffers can be set in the image memory 18, and the GPU 17 uses a buffer 18a among the buffers 18a as a frame buffer at the time of drawing a 3D object. In the present disclosure, the GPU 17 may be considered to correspond to the drawing processing unit. Note that, although the GPU 17 is formed as a different processor from the CPU 14 in the example described herein, the GPU 17 may be designed as a processor integrated with the CPU 14 in some cases.

The display controller 19 performs a process of outputting the image (two-dimensional image) obtained in the drawing process performed by the GPU 17, to the display 10. The display controller 19 of this example has functions as an image correction processing unit 19a. The functions as the image correction processing unit 19a include a function to correct an image of a virtual object Vo drawn two-dimensionally (position correction or deformation, for example), but the function will be described later in detail.

Here, in this example, a processing cycle of image outputting by the display controller 19 (a processing cycle of image correction by the image correction processing unit 19a) is shorter than a frame cycle of the imaging unit 11. For example, while a frame cycle of the imaging unit 11 is 60 Hz, a processing cycle of the display controller 19 is 120 Hz. A processing cycle of an object recognition process by the image recognition processing unit F1 described later matches a frame cycle of the imaging unit 11. Accordingly, a process cycle of the display controller 19 is shorter than a process cycle of an object recognition process.

The recording/reproduction control unit 20 performs recording/reproduction on a recording medium formed with a nonvolatile memory, for example. The recording/reproduction control unit 20 can take various forms in practice. For example, the recording/reproduction control unit 20 may be formed as a flash memory and a write/read circuit included in the information processing apparatus 1, or may be in the form of a card recording/reproducing unit that makes recording/reproducing access to a recording medium that can be detachably attached to the information processing apparatus 1, such as a memory card (a portable flash memory or the like), for example. Further, as a form included in the information processing apparatus 1, the recording/reproduction control unit 20 can be formed as a solid state drive (SSD), a hard disk drive (HDD), or the like.

The communication unit 21 performs a communication process and inter-device communication via a network. The CPU 14 can perform data communication with an external device via the communication unit 21.

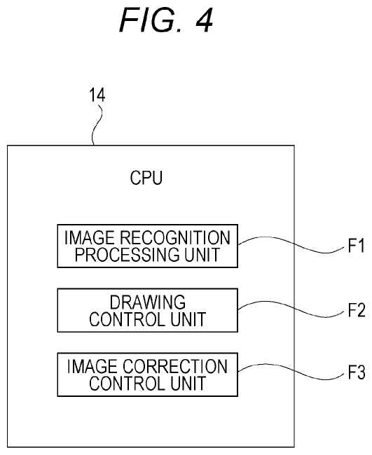

FIG. 4 is a diagram for explaining the functions of the CPU 14 of the information processing apparatus 1. As shown in the drawing, the CPU 14 has functions as an image recognition processing unit F1, a drawing control processing unit F2, and an image correction control unit F3.

The image recognition processing unit F1 performs a process (an object recognition process) of recognizing a real object Ro located in the real space, on the basis of captured images obtained by the imaging unit 11. Specifically, in the recognition process of this example, the type, the position, and the posture of the real object Ro in the real space are recognized. As described above, in this example, the distance to the real object Ro can be calculated on the basis of information about the parallax between stereoscopically captured images. The image recognition processing unit F1 recognizes the position of the real object Ro on the basis of the distance information.

The drawing control unit F2 performs drawing control on a virtual object Vo. Specifically, the GPU 17 is controlled so that the virtual object Vo in a desired posture is drawn at a desired position. In this example, the virtual object Vo is to be superimposed and displayed on the corresponding real object Ro. Therefore, on the basis of information about the position and the posture of the real object Ro obtained by the image recognition processing unit F1 performing the process of recognizing the real object Ro, the drawing control unit F2 controls the process of drawing the virtual object Vo being drawn by the GPU 17, so as to obtain a display image of the virtual object Vo at the position and the posture to be superimposed on the real object Ro.

Note that, in this example, a plurality of drawing planes can be used when a virtual object Vo is drawn with the GPU 17. The drawing control unit F2 in this example performs a process of changing the number of drawing planes to be used and switching usage modes of the drawing planes in accordance with the number, the type, and the like of virtual objects Vo to be drawn (the virtual objects Vo to be displayed to the user). This aspect will be described later in detail.

The image correction control unit F3 controls an image correction process being performed by the image correction processing unit 19a. By such control on the image correction process being performed by the image correction processing unit 19a, it is possible to adjust the position and the posture of a drawn image of the virtual object Vo displayed on the display 10. Note that the processes to be performed by the CPU 14 serving as the image correction control unit F3 will be described later in detail.

### 2. Delay Accompanying Drawing of a Virtual Object

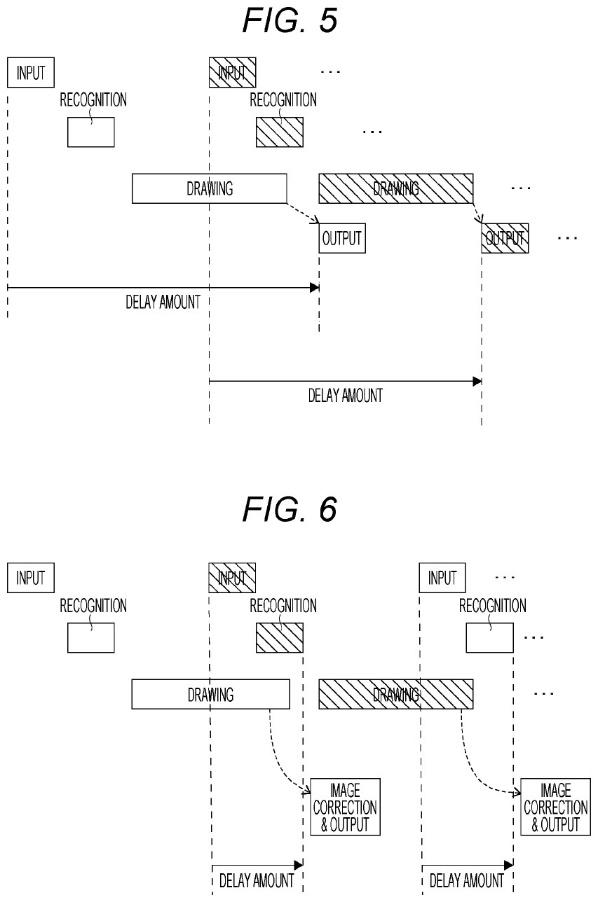

FIG. 5 is a diagram for explaining a delay accompanying drawing of a virtual object Vo. “INPUT” in the drawing means an input of information necessary for obtaining an object recognition result regarding a real object Ro. In this example, image capturing by the imaging unit 11 corresponds to this. Accordingly, a cycle of “input” shown in the drawing corresponds to a frame cycle of the imaging unit 11. Further, “RECOGNITION” in the drawing means object recognition of the real object Ro based on “INPUT” (particularly, recognition of the position of the real object Ro in this example). “DRAWING” means drawing of the virtual object Vo to be superimposed on the recognized real object Ro, and “OUTPUT” means an output of an image of the drawn virtual object Vo (an output to the display 10). Note that, as can be seen from the above explanation, “DRAWING” should be performed on the basis of a result of recognition of the position and the posture of the real object Ro on which the virtual object Vo is to be superimposed, and be started after the completion of “RECOGNITION”.

As shown in the drawing, while “INPUT” is repeated in predetermined cycles, “RECOGNITION”, “DRAWING”, and “OUTPUT” are sequentially performed for each “INPUT”. In this process, the time required from an “INPUT” to an “OUTPUT” is the display delay amount of the virtual object Vo with respect to the real object Ro. By conventional techniques, an image of a virtual object Vo obtained by “DRAWING” is output without any change, and therefore, the time required for “DRAWING” is directly reflected by the display delay amount of the virtual object Vo. Because a relatively long time is required for drawing a virtual object Vo that is a 3D object, it is difficult to shorten the display delay by conventional techniques.

### 3. Delay Shortening Method as an Embodiment

FIG. 6 is a diagram for explaining a delay shortening method as an embodiment. To shorten the display delay of a virtual object Vo, instead of outputting an image of the virtual object Vo that has been drawn on the basis of a result of the latest object recognition as in conventional cases, this embodiment adopts a technique by which, after a result of the latest object recognition is obtained, an image of the virtual object Vo that has been drawn on the basis of a result of past object recognition is corrected on the basis of a result of the latest object recognition. In other words, the image obtained through a process of drawing the virtual object Vo on the basis of the recognition result of an object recognition process performed at a first time point is corrected on the basis of the recognition result of an object recognition process performed at a second time point after the first time point.

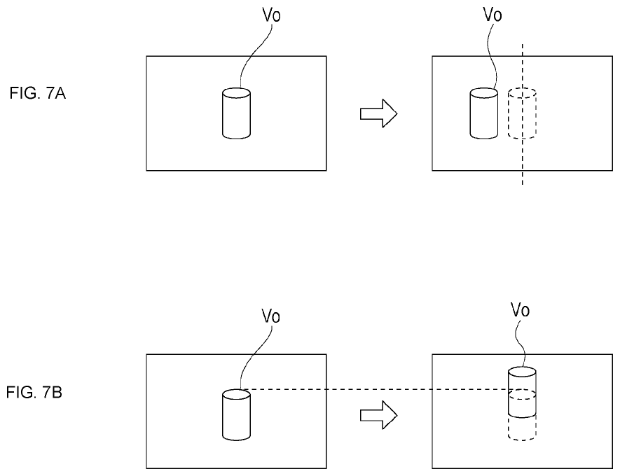

The image correction herein is performed by the image correction processing unit 19a described above. Specifically, in a case where the superimposition-target real object Ro has moved to the left during the time from the first time point to the second time point, for example, the image correction is performed to move the virtual object Vo, which has been drawn on the basis of the object recognition result at the first time point, to the left in the drawing frame. FIG. 7A illustrates the correction. Alternatively, in a case where the superimposition-target real object Ro has moved upward during the time from the first time point to the second time point, the image correction is performed to move the virtual object Vo, which has been drawn based on the object recognition result at the first time point, upward in the drawing frame (see FIG. 7B). As described above, in this example, correction for changing the position of the drawn virtual object Vo in a vertical and horizontal plane in the frame is performed in accordance with a change in the position of the real object Ro in a vertical and horizontal plane. In other words, on the basis of information about the position of the real object Ro in a vertical and horizontal plane as recognized by the object recognition process, correction is performed to change the position of the virtual object Vo in the vertical and horizontal plane of the image drawn by the drawing process.

Further, in a case where the posture of the real object Ro has changed, such as a case where the superimposition-target real object Ro has rotated rightward during the time from the first time point to the second time point, the image correction for the virtual object Vo drawn on the basis of the object recognition result at the first time point is correction to be performed to change the posture of the virtual object Vo in the drawing frame so as to follow the recognized change in the posture of the real object Ro, such as rotating the virtual object Vo rightward in the drawing frame, for example.

Furthermore, in a case where the superimposition-target real object Ro has moved toward the front side (in the direction toward the user) or toward the back side during the time from the first time point to the second time point, the image correction is performed to increase or decrease the size of the virtual object Vo drawn on the basis of the object recognition result at the first time point. In other words, on the basis of information about the position of the real object Ro in the depth direction as recognized by the object recognition process, correction is performed to change the size of the virtual object Vo in the image drawn by the drawing process.

As the image correction based on an object recognition result is performed as described above, the position and the posture of the virtual object Vo can be made to appropriately follow changes in the position and the posture of the real object Ro in a case where the real object Ro on which the virtual object Vo is to be superimposed is a moving object. Furthermore, in a case where such image correction is performed, an image of the virtual object Vo can be output without the drawing process based on the latest object recognition result after the latest object recognition result is obtained, as shown in FIG. 6. Thus, the display delay amounts can be shortened by a large amount, compared with those in the case illustrated in FIG. 5. To shorten the display delay amounts in this case, the image correction based on the latest object recognition result (the result of recognition by the second recognition process) is performed before the drawing process (the second drawing process) performed on the basis of the latest object recognition result is completed.

Note that, for confirmation, the image correction process by the image correction processing unit 19a is a process for a two-dimensional image, and accordingly, the processing time is significantly shorter than that of the drawing process by the GPU 17. Also, the image correction process based on an object recognition result is performed by the display controller 19 provided outside the CPU 14 in the example configuration described herein. However, the CPU 14 can also perform the image correction process. Alternatively, at least a function of the image correction process can be executed by the display controller 19 in cooperation with the CPU 14 in some other configuration.

Here, between the first time point and the second time point described above, the viewpoint position or the line-of-sight direction might change due to movement of the user's head or the like. Such a relative difference between the real object Ro and the virtual object Vo due to a change in the viewpoint position or the line-of-sight direction cannot be reduced only by the above-described image correction based on an object recognition result.

Therefore, in this example, image correction based on detection signals of the sensor unit 13 is also performed as the image correction using the image correction processing unit 19a.

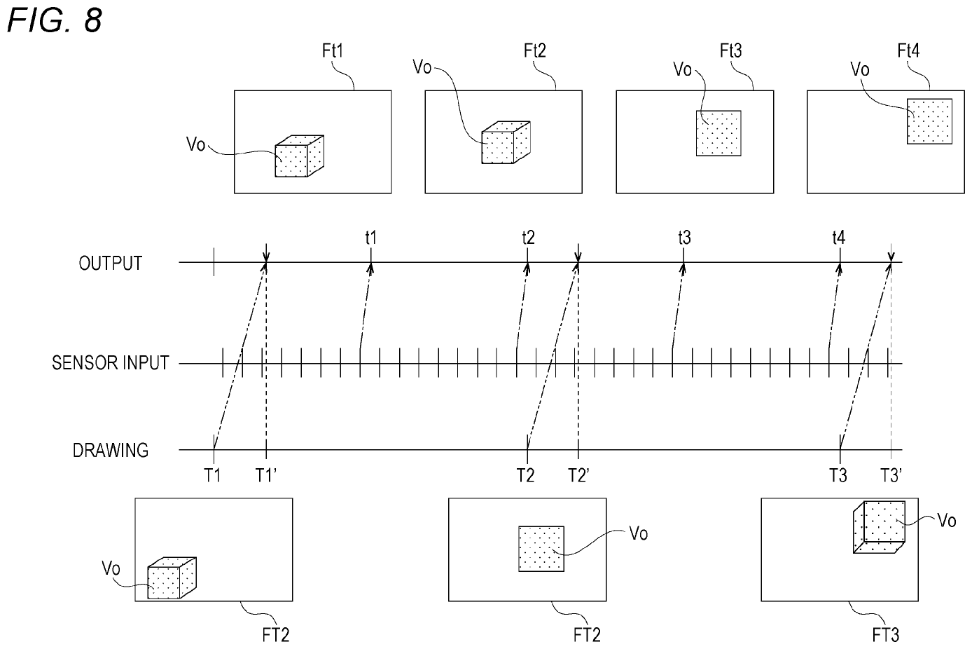

FIG. 8 is a diagram for explaining the image correction based on detection signals of the sensor unit 13. FIG. 8 schematically shows the process timings along the respective time series of drawing of a virtual object, sensor inputs (inputs of a detection signal of the sensor unit 13) for detecting the viewpoint position and the line-of-sight direction of the user, and outputs of the drawn virtual object Vo.

In FIG. 8, time points T1 to T3 indicate the timings to start the drawing of the virtual object Vo, and time points T1′ to T3′ indicate the timings to end the drawing of the virtual object Vo. Also, frame images FT1 to FT3 indicate an example of the respective frame images drawn at the time points T1 to T3, and schematically show the shapes and positions of the virtual object Vo in the images. Further, in FIG. 8, time points t1 to t4 indicate the timings to output the images of the virtual object Vo to the display 10. Frame images Ft1 to Ft4 indicate an example of the frame images output at the time points t1 to t4, and schematically show the shapes and positions of the virtual object Vo in the images. Here, as shown in FIG. 8, a sensor input is acquired in shorter cycles than (at a higher frequency than) the cycles (frequency) in (at) which the virtual object Vo is drawn.

First, drawing of the virtual object Vo is started at the time point T1, the drawing is completed at the time point T1′, and the frame image FT1 is obtained. After that, at the time point t1, which is an image output timing, the position of the virtual object Vo in the frame image FT1 is corrected on the basis of a sensor input that has been made immediately before the time point t1, and the corrected image is then output as the frame image Ft1. Next, at the time point t2, which is an image output timing, the drawing at the time point T2 has not been performed yet. Therefore, the position of the virtual object Vo in the frame image FT1 is corrected on the basis of a sensor input that has been made immediately before the time point t2, and the image obtained by the correction is output as the frame image Ft2.

Next, at the time point T2, drawing of the virtual object Vo is started, the drawing is ended at the time point T2′, and the frame image FT2 is obtained. That is, at the time points t3 and t4, which are output timings that come after the time point T2′, the frame images Ft3 and Ft4 in which the position of the virtual object Vo in the frame image FT2 has been corrected on the basis of sensor inputs that have been made immediately before the respective timings are output. Note that, in the illustrated example, the drawing at the time point T3 is started after the output timing at the time point t4, but, at the output timings after the time point T3, frame images obtained by correcting the position of the virtual object Vo in the frame image FT3 on the basis of the sensor inputs made immediately before the respective timings are output, unless new drawing is performed after the time point T3.

As the image correction based on sensor signals is performed as described above, even if the viewpoint position or the line-of-sight direction of the user changes between the first time point and the second time point, the position of the virtual object Vo in a drawn image can be corrected so as to follow the change. That is, it is possible to shorten the display delay of the virtual object Vo due to a change in the line-of-sight position or the line-of-sight direction of the user.

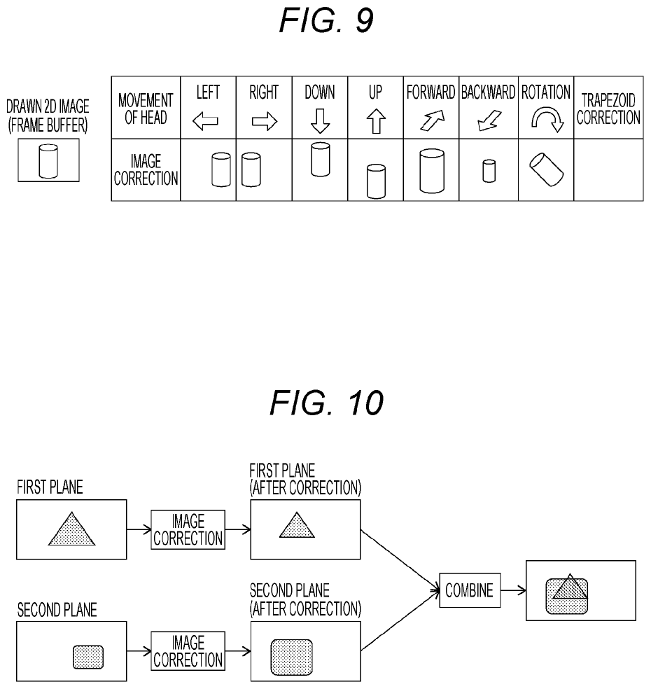

Here, a pattern of image correction based on sensor signals as described above is now explained with reference to FIG. 9. As shown in FIG. 9, in a case where the movement of the head of the user (movement of the viewpoint position and the line-of-sight direction) is in the leftward direction or the rightward direction, correction is performed to change the position of the virtual object Vo in the drawing frame in the rightward direction or the left direction. Also, in a case where the movement of the head of the user is in the downward direction or the upward direction, correction is performed to change the position of the virtual object Vo in the drawing frame in the upward direction or the downward direction. Further, in a case where the user's head moves forward (or approaches the superimposition-target real object Ro) or moves backward, correction is performed to increase or decrease the size of the virtual object Vo. As for rotation, image correction is performed to rotate the virtual object Vo in a direction opposite to the movement of the head.

Furthermore, in this example, trapezoid correction can be performed as image correction by the image correction processing unit 19a. This trapezoid correction is also performed in accordance with movement of the head detected from sensor inputs.

Here, in a case where different virtual objects Vo are superimposed on different real objects Ro, image correction based on the above-described object recognition result or sensor signals may be performed for each virtual object Vo. In a case where individual image correction is to be performed for each virtual object Vo in this manner, it is ideal that each virtual object Vo is drawn with a different drawing plane, and image correction for each virtual object Vo is performed on the frame image obtained by each drawing process.

FIG. 10 is a diagram for explaining image correction after a plurality of virtual objects Vo is drawn with different drawing planes. The image correction is to be performed on the assumption that the information processing apparatus 1 of this example can use two drawing planes: a first plane and a second plane. For confirmation, a drawing plane corresponds to a display screen on the display 10, and means a frame in which a 3D object that is a virtual object Vo is drawn as two-dimensional image information. One drawing plane corresponds to one buffer 18a in the image memory 18. In a case where there is a plurality of drawing planes, it is possible to draw different virtual objects Vo in the drawing planes, combine the drawn images, and show image information about the respective virtual objects Vo on the display screen. The display controller 19 of this example can then perform an image correction process on each of the first plane and the second plane. In other words, different image correction processes can be performed on the respective drawing planes.

Note that FIG. 10 shows an example in which the positions of two virtual objects Vo overlap in the combined frame. In this case, which virtual object Vo is to be on the front side is determined on the basis of the position (distance) of the target real object Ro in the depth direction.

However, it is not desirable to simultaneously draw a plurality of virtual objects Vo, because doing so will lead to an increase in the processing load. Therefore, in this example, control for switching usage modes of the drawing plane, the drawing update cycles, or the like is performed in accordance with the number and the type of the virtual objects Vo to be displayed. Note that this aspect will be described below in detail.

### 4. Processing Procedures

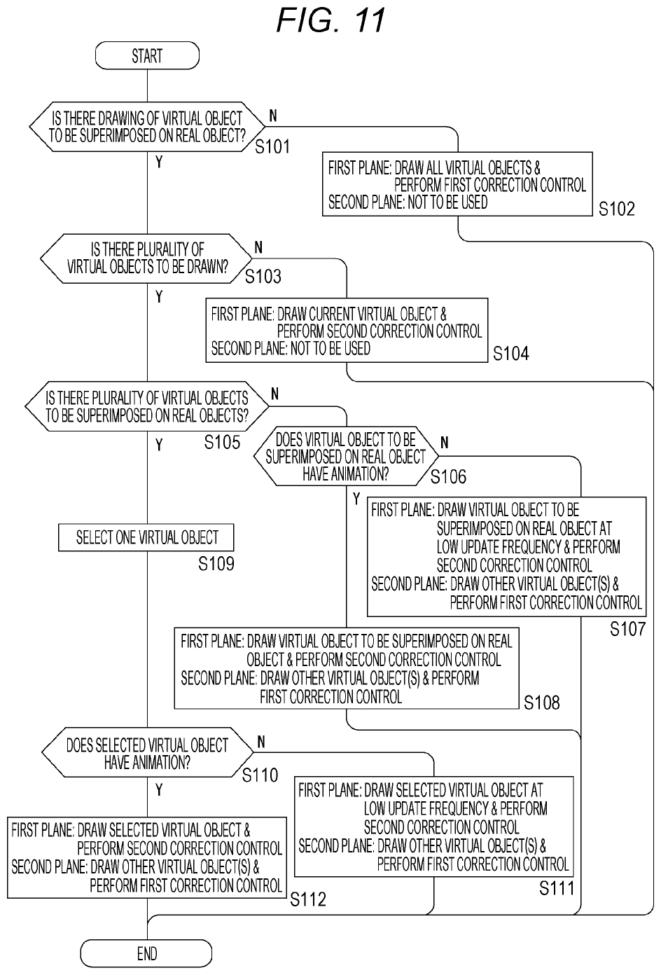

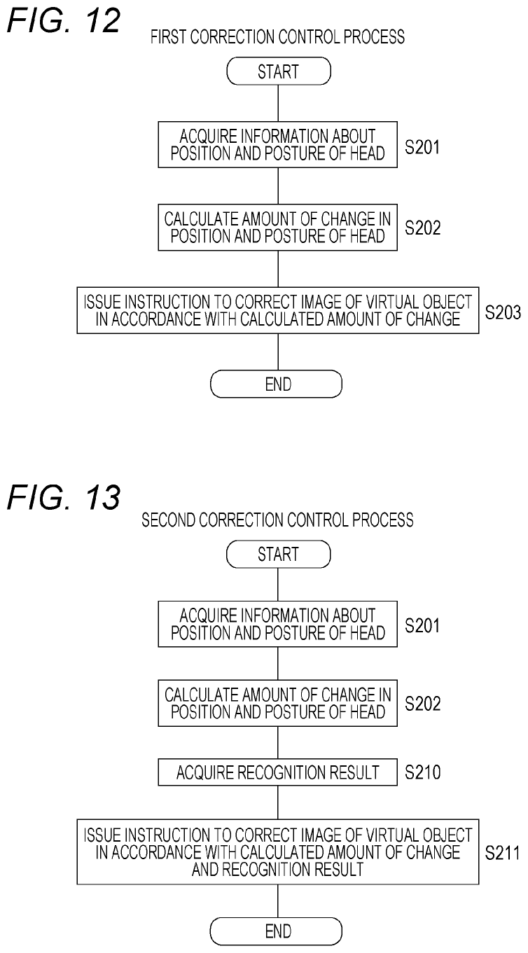

The flowcharts in FIGS. 11 to 13 show examples of specific processing procedures to be carried out by the CPU 14 as the drawing control unit F2 and the image correction control unit F3 described above. Note that these processes shown in FIGS. 11 to 13 are performed by the CPU 14, on the basis of a program stored in the ROM 15 or a program stored in a storage device that can be read by the recording/reproduction control unit 20.

FIG. 11 shows processes compatible with the drawing control unit F2. First, in step S101, the CPU 14 determines whether or not there is a drawing of a virtual object Vo to be superimposed on a real object Ro. If there is not a drawing of the virtual object Vo, the CPU 14 performs a drawing setting and image correction setting process in step S102, and ends the series of processes shown in FIG. 11. In the drawing setting and image correction setting process in step S102, the CPU 14 controls the GPU 17 to use the first plane for drawing all the virtual objects Vo, and performs first correction control as the control on the image correction process for the virtual objects Vo drawn with the first plane. Also, in the drawing setting and image correction setting process in step S102, the CPU 14 disables the use of the second plane.

Here, the first correction control means control to perform image correction based on the sensor signals as described above. That is, according to the processes in steps S101 and S102 described above, in a case where the virtual objects Vo to be drawn (and to be displayed) are virtual objects Vo (non-related virtual objects) not to be superimposed on a real object Ro, only image correction based on sensor signals is performed as the image correction for all the virtual objects Vo. Further, at this point of time, there is no need to perform drawing with a drawing plane separated for each virtual object Vo, and therefore, the use of the second plane is disabled.

Note that examples of virtual objects Vo not to be superimposed on a real object Ro include a virtual object Vo to be disposed and fixed at a predetermined position in an AR space.

FIG. 12 shows the process for performing the first correction control. First, in step S201, the CPU 14 acquires information about the position and the posture of the head. This is a process of acquiring information about the position and the posture of the user's head (information about the line-of-sight position and the line-of-sight direction), on the basis of detection signals of the sensor unit 13. Note that a sensor signal acquisition cycle is shorter than a cycle of drawing a virtual object Vo and an image output cycle to the display 10 as described above.

In step S202 following step S201, the CPU 14 calculates the amount of change in the position and the posture of the head. As can be seen from FIG. 8 explained above, the amount of change calculated herein is the amount of change during the period from the latest drawing start time point to the sensor signal acquisition time point immediately before the output.

Next, in step S203, the CPU 14 issues an instruction to correct an image of the virtual object Vo in accordance with the calculated amount of change, and then ends the first correction control process shown in FIG. 12. Here, as can be seen from FIG. 9 and others described above, the image correction processing unit 19a can perform the respective image correction processes, such as changing the displacement or the size in each of the upward, downward, rightward, and leftward directions, changing the posture by rotation or the like, and performing the trapezoid correction, as the image correction for the virtual object Vo. The process to be performed in step S203 is a process of calculating the respective correction parameters for changing the displacement and the size in each of the upward, downward, rightward, and leftward directions, changing the posture by rotation or the like, performing the trapezoid correction, and the like on the basis of the amount of change in the position and the posture calculated in step S202, and notifying the image correction processing unit 19a (the display controller 19) of the respective calculated correction parameters.

The explanation returns to FIG. 11. If it is determined in step S101 that there is a drawing of a virtual object Vo to be superimposed on a real object Ro, the CPU 14 moves on to step S103, and determines whether or not there is a plurality of virtual objects Vo to be drawn. If the number of virtual objects Vo to be drawn is not plural, or if the number of virtual objects Vo to be drawn is only one virtual object Vo to be superimposed on a real object Ro, the CPU 14 performs a drawing setting and image correction setting process in step S104, and then ends the series of processes shown in FIG. 11. In the drawing setting and image correction setting process in step S104, the CPU 14 controls the GPU 17 to use the first plane for drawing the current virtual object Vo, and performs second correction control as the control on the image correction process for the virtual object Vo drawn with the first plane. Also, in the drawing setting and image correction setting process in step S104, the CPU 14 disables the use of the second plane.

The second correction control means performing control so as to perform image correction based on both sensor signals and an object recognition result. That is, according to the processes in steps S103 and S104 described above, in a case where the number of virtual objects Vo to be drawn is only one virtual object Vo to be superimposed on a real object Ro, image correction based on both sensor signals and an object recognition result is performed as the image correction for the virtual object Vo. Further, at this point of time, there is no need to perform drawing with a drawing plane separated for each virtual object Vo, and therefore, the use of the second plane is disabled.

FIG. 13 shows the process for performing the second correction control. First, to perform image correction based on sensor signals, the CPU 14 also performs the processes in steps S201 and S202 in this case, to calculate the amount of change in the position and the posture of the head. After performing the process in step S202, the CPU 14 then acquires a recognition result in step S210. That is, information about the position and the posture of the corresponding real object Ro recognized in the recognition process performed for the real object Ro is acquired.

In step S211 following step S210, the CPU 14 issues an instruction to correct an image of the virtual object Vo in accordance with the calculated amount of change and the recognition result, and then ends the second correction control process shown in FIG. 13. In the process in step S211, the CPU 14 first calculates the amount of change in the real object Ro during the period from the first time point to the second time point described above, on the basis of the recognition result acquired in step S210. Further, on the basis of such an amount of change in the real object Ro and the amount of change calculated in step S202, the following process is performed: calculating the correction parameters for the image correction processing unit 19a to change the displacement and the size in each of the upward, downward, rightward, and leftward directions described above, change the posture by rotation or the like, perform the trapezoid correction, and the like; and notifying the image correction processing unit 19a (the display controller 19) of the respective calculated correction parameters.

Referring back to FIG. 11, if it is determined in step S103 that there is a plurality of virtual objects Vo to be drawn, the CPU 14 moves on to step S105, and determines whether or not there is a plurality of virtual objects Vo to be superimposed on a real object Ro. If it is determined that there is not a plurality of virtual objects Vo to be superimposed on a real object Ro, or if it is determined that the virtual objects Vo to be drawn are only one virtual object Vo to be superimposed on a real object Ro and (one or a plurality of) virtual objects Vo not to be superimposed on a real object Ro, the CPU 14 moves on to step S106, and determines whether or not the virtual object Vo to be superimposed on a real object Ro has an animation. An animation herein is assumed to be an animation in which at least one of the color, the pattern, and the shape of a virtual object Vo is changed in response to the occurrence of a predetermined event with respect to the virtual object Vo, such as the user's hand coming into contact (virtual contact) with the virtual object Vo in an AR space, for example. Note that a virtual object Vo “having an animation” can be rephrased as a virtual object Vo “performing animation”.

If it is determined in step S106 that the virtual object Vo to be superimposed on a real object Ro has no animation, the CPU 14 performs a drawing setting and image correction setting process in step S107, and then ends the series of processes shown in FIG. 11. In the drawing setting and image correction setting process in step S107, the CPU 14 controls the GPU 17 so as to use the first plane for drawing the virtual object Vo to be superimposed on a real object Ro and perform the drawing at a low update frequency, and performs the second correction control as the control on the image correction process for the virtual object Vo drawn with the first plane. Also, in the drawing setting and image correction setting process in step S107, the CPU 14 controls the GPU 17 to use the second plane for drawing the other virtual object(s) Vo, and performs the first correction control as the control on the image correction process for the virtual object(s) Vo drawn with the second plane.

In the case leading to step S107, there coexist the virtual object Vo to be superimposed on a real object Ro, and the virtual object(s) Vo not to be superimposed on a real object Ro. However, if the second correction control is performed simultaneously on the former virtual object Vo and the latter virtual object(s) Vo, there is a possibility that the latter virtual object(s) Vo will not be displayed at an appropriate position. For this reason, different drawing planes are used for the virtual object Vo to be superimposed on a real object Ro and the virtual object(s) Vo not to be superimposed on a real object Ro, so that each virtual object Vo is displayed at an appropriate position. At this point of time, if the drawing for each of the two drawing planes is performed at a normal update frequency, the processing load then increases, which is undesirable. Therefore, the virtual object Vo to be superimposed on a real object Ro is drawn at a lower update frequency than usual. Here, in this example, the normal update frequency of the drawing process is 60 Hz, and the low update frequency is a lower update frequency than that, such as 30 Hz, for example.

Note that, in step S107, the drawing update frequency with the second plane can also be set at the low update frequency. In this regard, the same applies to the drawing with the second plane in steps S108, S111, and S112 described below.

If it is determined in step S106 that the virtual object Vo to be superimposed on a real object Ro has an animation, on the other hand, the CPU 14 performs a drawing setting and image correction setting process in step S108, and then ends the series of processes shown in FIG. 11. In the drawing setting and image correction setting process in step S108, the CPU 14 controls the GPU 17 so as to use the first plane for drawing the virtual object Vo to be superimposed on a real object Ro, and performs the second correction control as the control on the image correction process for the virtual object Vo drawn with the first plane. Also, in the drawing setting and image correction setting process in step S108, the CPU 14 controls the GPU 17 to use the second plane for drawing the other virtual object(s) Vo, and performs the first correction control as the control on the image correction process for the virtual object(s) Vo drawn with the second plane.

In a case where the virtual object Vo to be superimposed on a real object Ro has an animation as described above, the drawing update frequency for the virtual object Vo is not lowered. With this arrangement, it is possible to prevent a decrease in the accuracy of the animation of the virtual object Vo.

If it is determined in step S105 that there is a plurality of virtual objects Vo to be superimposed on a real object Ro, on the other hand, the CPU 14 moves on to step S109, and performs a process of selecting one virtual object Vo, which is a process of selecting one virtual object Vo from the plurality of virtual objects Vo to be superimposed on a real object Ro.

Here, in the selection process in step S109, a virtual object Vo is selected on the basis of the magnitude of motion, the area, or the like of the real object Ro as the superimposition target. In a basic idea, a virtual object Vo having a large projection error is selected. Specifically, the index value S of a projection error as shown below is calculated for each virtual object Vo, and the virtual object Vo having the greatest index value S is selected. Note that, in the equation shown below, the area a is the area of the real object Ro as the superimposition target (the area of the surface that can be seen from the user's viewpoint), and the movement amount m is the movement amount of the real object Ro as the superimposition target.

Index value S=(1/area a)×movement amount m

Further, because any details about the person are not known other than the point of gaze, calculation is performed according to the equation shown below, where a represents the distance to the point of gaze (the reciprocal of the distance between the point of gaze and the real object Ro).

Index value S′=(1/area a)×movement amount m×α

Thus, the virtual object Vo having the greatest index value S′ can be selected. Here, the point of gaze is only required to be a predetermined position that the user gazes at, such as the position that is the screen center point of the display 17. Alternatively, a component that performs detection of the user's line of sight can use a position that is estimated from a line-of-sight detection result.

Note that, in the selection process in step S109, the area a can be replaced with a simple model (such as a bounding box, for example) because the costs of accurate calculation of the area a is too high. Further, because switching selected virtual objects Vo at a high frequency is undesirable for the user, providing hysteresis is effective. For example, once a virtual object Vo is selected, the index value S (or the index value S′) is multiplied by a predetermined amount, such as by 1.2. Thus, switching becomes difficult. Further, in a case where priority is given to power consumption, all the virtual objects Vo may be drawn in the same plane if the index values S (S′) of all the virtual objects Vo are equal to or smaller than a certain value.

In step S110 following step S109, the CPU 14 determines whether or not the selected virtual object Vo has an animation. If the selected virtual object Vo does not have an animation, the CPU 14 performs a drawing setting and image correction setting process in step S111, and terminates the series of processes shown in FIG. 11. In the drawing setting and image correction setting process in step S111, the CPU 14 controls the GPU 17 so as to use the first plane for drawing the selected virtual object Vo and perform the drawing at a low update frequency, and performs the second correction control as the control on the image correction process for the virtual object Vo drawn with the first plane. Also, in the drawing setting and image correction setting process in step S111, the CPU 14 controls the GPU 17 to use the second plane for drawing the other virtual object(s) Vo, and performs the first correction control as the control on the image correction process for the virtual object(s) Vo drawn with the second plane.

If it is determined in step S110 that the selected virtual object Vo has an animation, on the other hand, the CPU 14 performs a drawing setting and image correction setting process in step S112, and then ends the series of processes shown in FIG. 11. In the drawing setting and image correction setting process in step S112, the CPU 14 controls the GPU 17 to use the first plane for drawing the selected virtual object Vo, and performs the second correction control as the control on the image correction process for the virtual object Vo drawn with the first plane. Also, in the drawing setting and image correction setting process in step S112, the CPU 14 controls the GPU 17 to use the second plane for drawing the other virtual object(s) Vo, and performs the first correction control as the control on the image correction process for the virtual object(s) Vo drawn with the second plane.

As described above, in this example, in a case where there is a plurality of virtual objects Vo to be superimposed on a real object Ro to cope with a case where there are only two drawing planes, one virtual object Vo is selected, and the selected virtual object Vo is exclusively drawn with the use of a single drawing plane. The term “exclusively” as used herein means that only a single virtual object is drawn with a single drawing plane, and two or more virtual objects Vo are not drawn simultaneously with the single drawing plane.

As a virtual object Vo is selected in such a manner, image correction based on an object recognition result is preferentially performed for one virtual object Vo, in a case where it is impossible to perform image correction based on object recognition results regarding all the virtual objects Vo to be superimposed on a real object Ro because of the relationship between the number of drawing planes and the number of virtual objects Vo to be superimposed on a real object Ro.

Here, although an example case where only two drawing planes are available has been described above, a virtual object Vo that exclusively uses a drawing plane can be selected on the basis of a similar idea even in a case where the number of available drawing planes is three or more. For example, it is assumed that the number of drawing planes is three, and the number of virtual objects Vo to be superimposed on a real object Ro is three or more. In this case, the number of virtual objects Vo that can exclusively use a drawing plane can be two, and accordingly, two virtual objects Vo are selected from the three or more virtual objects Vo. In general, in a case where the number of virtual objects Vo (related virtual objects) to be superimposed on a real object Ro is equal to or larger than the number of drawing planes, (n−1) related virtual objects are selected when the number of drawing planes is n (n being a natural number of 2 or greater). The selected related virtual objects are then exclusively drawn with drawing planes (that is, one virtual object Vo is drawn with only one drawing plane), and all the virtual objects other than the selected related virtual objects among the virtual objects to be displayed are drawn with a remaining one drawing plane. In the present disclosure, a related virtual object may be regarded as a virtual object having a fixed relative positional relationship with the absolute position or posture of a real object Ro. The display position of a related virtual object may be corrected not only on the basis of a result of image recognition (an object recognition result) of a real object Ro but also with reference to a result of self-location estimation described later.

As a result, in a case where virtual objects Vo to be displayed include a virtual object Vo that is not to be superimposed on a real object Ro (that is, a non-related virtual object for which image correction based on an object recognition result is unnecessary), and the number of related virtual objects is equal to or larger than n while the number of drawing planes is n, it is possible to perform image correction based on a result of recognition of a related real object Ro for the (n−1) related virtual objects, and perform image correction in accordance with the viewpoint position and the line-of-sight direction of the user for the remaining related virtual objects as well as the non-related virtual objects. That is, in a case where image correction based on a result of recognition of a real object Ro cannot be performed for all the related virtual objects because of the relationship between the number of drawing planes and the number of related virtual objects, image correction according to a result of recognition of a real object is preferentially allowed to be performed for the (n−1) related virtual objects. In the present disclosure, a non-related virtual object may be regarded as a virtual object Vo whose position and posture are controlled independently of the absolute position and posture of a specific real object Ro. In other words, the position and posture of a non-related virtual object are determined not depending on any result of image recognition of a specific real object Ro. For example, the display position of a non-related virtual object is determined in an absolute coordinate system (a three-dimensional coordinate system) of the real space, on the basis of a result of self-location estimation described later. Alternatively, a non-related virtual object may be a virtual object (a GUI, for example) displayed in a relative coordinate system whose origin is the position of the display device.

Here, to enhance the effect to shorten the display delays of virtual objects Vo, it is desirable to appropriately adjust the phase of the processing timings (the phase of the operation clock) between the side of the object recognition process and the side of the process of outputting images to the display 10.

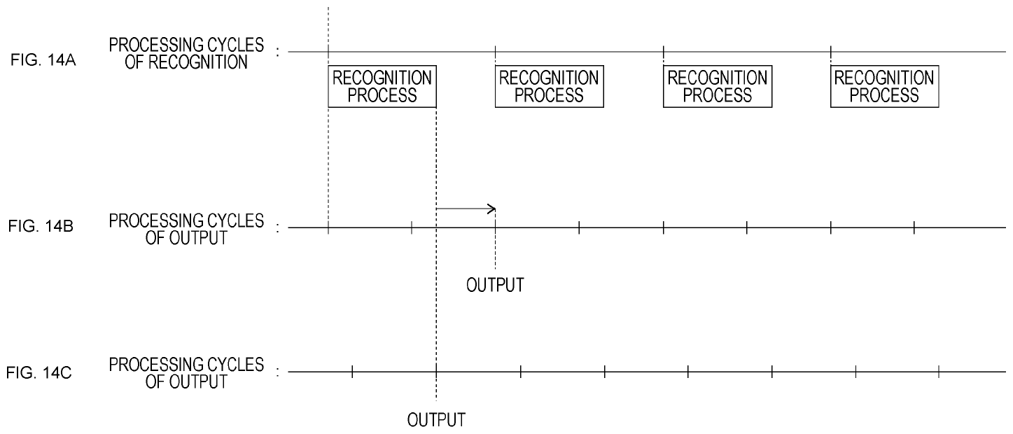

FIG. 14 is a diagram for explaining phase adjustment of the processing timings between the side of the recognition process and the side of the output process. FIG. 14A shows the processing cycles of the recognition process, and the execution period of the recognition process within one cycle. FIGS. 14B and 14C show the processing cycles of the output process. As described above, a processing cycle of the output process (which is a processing cycle of the image correction processing unit 19a, such as 120 Hz, for example) is shorter than a processing cycle of the recognition process (60 Hz, for example).

In the phase relationship shown as comparison between FIG. 14A and FIG. 14B, the error time (see an arrow in the drawing) from the timing of completion of the recognition process to the start of the image output is relatively long, and this error time is reflected by a display delay time of the virtual object Vo. In the phase relationship shown as comparison between FIGS. 14A and 14C, on the other hand, the timing of completion of the recognition process and the timing of the start of the image output are substantially the same, and the error time can be shortened to almost 0. That is, the effect to shorten the display delays of the virtual object Vo can be made greater than that in the case shown in FIG. 14B.

### 5. Another Example of Reduction of the Drawing Processing Load

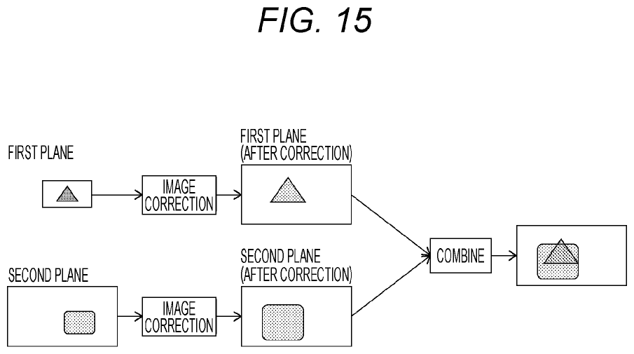

In the example described above, the drawing update frequency of at least one drawing plane is lowered so as to reduce the drawing processing load. However, it is also possible to reduce the drawing processing load by reducing the size of at least one drawing plane, as in an example shown in FIG. 15, for example. In the example shown in the drawing, the size of the first plane is made smaller in a case where the first plane and the second plane are used. Note that it is possible to reduce the size of a drawing plane by reducing the size of the buffer 18a (frame buffer) to be used as the drawing plane. Reducing the size of a drawing plane herein means using a drawing plane whose size is made smaller than the other drawing planes. Note that, when a virtual object Vo drawn with a reduced drawing plane is combined with a virtual object Vo drawn with another drawing plane, the virtual object Vo drawn with the reduced drawing plane is enlarged to match the size of the virtual object Vo drawn with another drawing plane, and is then combined with the virtual object Vo drawn with another drawing plane.

### 6. Shielding Virtual Object

In the AR system 50, a virtual object Vo is not necessarily to be superimposed on a real object Ro that is not the user as shown in FIG. 1, but may be a virtual object to be superimposed on a part of the user's body. For example, when a virtual object overlaps a part of the user's body seen from the viewpoint position of the user, a virtual object Vo that shields the overlapping portion of the virtual object can be adopted (this virtual object Vo will be hereinafter referred to as a “shielding virtual object”). An example of the shielding virtual object can be a virtual object Vo in the form of a hand of the user (a virtual object Vo in the shape of a hand). The shielding virtual object can be rephrased as area information for defining a shielding area for another virtual object Vo.

Image correction based on an object recognition result can also be performed on such a shielding virtual object. That is, image correction is performed on the shielding virtual object, on the basis of a result of object recognition regarding the corresponding part of the body. Specifically, the CPU 14 in that case performs the processes shown in FIG. 11 described above, with the shielding virtual object being included in one of the “virtual objects Vo to be superimposed on a real object Ro”.

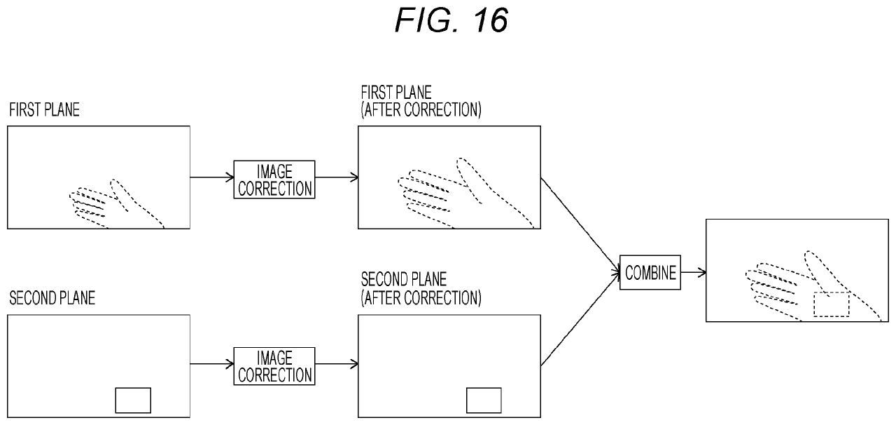

FIG. 16 shows an example in which another virtual object Vo is shielded by a shielding virtual object. In the example shown in this drawing, the shielding virtual object is in the form of a hand of the user. Further, the first plane is used for drawing the shielding virtual object, and the second plane is used for drawing another virtual object Vo. In this case, the image correction processing unit 19a performs image correction on the shielding virtual object drawn with the first plane, on the basis of a result of object recognition regarding the hand of the user. In the example shown in the drawing, correction is performed to enlarge the shielding virtual object, in response to movement of the user's hand toward the front side. Meanwhile, the image correction processing unit 19a performs image correction on the other virtual object Vo drawn with the second plane, on the basis of a result of object recognition regarding the real object Ro corresponding to the other virtual object Vo. The respective corrected images are then combined and output to the display 10. If the shielding virtual object is located on the front side at this point of time, the other virtual object Vo located behind that is shielded at the portion overlapping the shielding virtual object. In the example shown in the drawing, the entire area of the other virtual object Vo overlaps the shielding virtual object. In this case, the entire area of the other virtual object Vo is shielded and is in a non-displayed state.

As image correction based on an object recognition result is performed on such a shielding virtual object, a display delay of the shielding virtual object can be shortened. That is, it is possible to alleviate the user's feeling of strangeness that may be caused when the overlapping portion of a virtual object Vo is not shielded, though a part of the user's body overlaps the virtual object Vo viewed from the viewpoint position of the user.

Here, in a case where a plurality of drawing planes can be used, and image correction is performed on a shielding virtual object, at least one of the drawing planes can be used as the drawing plane exclusively for the shielding virtual object. With this arrangement, image correction based on an object recognition result regarding the shielding virtual object can be preferentially performed, and it is possible to more easily alleviate the user's feeling of strangeness that may be caused by an unshielded overlapping portion between a part of the user's body and a virtual object Vo. 7. Shadow Display

To increase the feeling of reality in displaying a virtual object Vo, it is effective to display the shadow (virtual shadow) of the virtual object Vo.

A virtual shadow is also required to follow movement of a virtual object Vo. However, to shorten the display delay, image correction based on the latest object recognition result like image correction for the virtual object Vo may also be performed on an image in which the virtual shadow is drawn (this image will be hereinafter referred to as a “virtual shadow image”).

However, if image correction is performed on the virtual shadow image in which the virtual shadow is drawn in this manner on the basis of an object recognition result, there is a possibility that an appropriate shadow expression corresponding to the movement of the object will not be achieved.

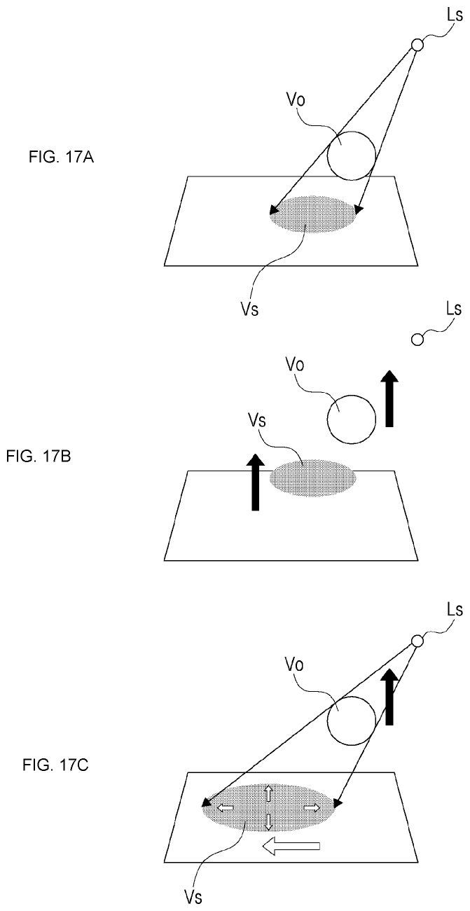

FIG. 17 is a diagram for explaining the problems in a case where image correction based on an object recognition result is applied to a virtual shadow image.

FIG. 17A shows an example state of a virtual shadow Vs that is formed when a virtual object Vo is irradiated with light from a virtual light source Ls.

When the position of the virtual object Vo moves upward on the paper surface in the state shown in FIG. 17A, the correct shadow expression shown in FIG. 17C cannot be achieved if the virtual shadow image is corrected so as to move the virtual shadow Vs in the same direction and by the same amount as the moving direction and the moving amount of the virtual object Vo as shown in FIG. 17B. As shown in FIG. 17C, as the virtual object Vo moves upward, the center of the shadow should be shifted to the left on the paper surface, and the range of the shadow should be widened in this case.

As described above, if image correction according to the movement of the object is performed on the target virtual shadow image in which the virtual shadow Vs is drawn, a correct shadow expression cannot be achieved.

Therefore, in the description below, an information processing apparatus 1A for shortening the display delay of the virtual shadow Vs while achieving a correct shadow expression will be described.

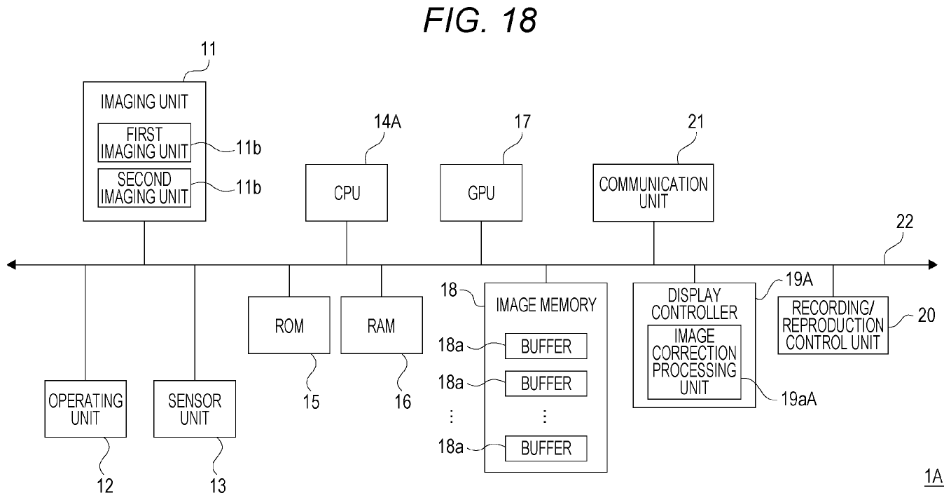

FIG. 18 is a block diagram showing an example internal configuration of the information processing apparatus 1A. Note that, in the description below, components similar to those already described are denoted by the same reference numerals as above, and explanation thereof is not made herein.

The differences from the information processing apparatus 1 shown in FIG. 3 are that a CPU 14A is provided in place of the CPU 14, and a display controller 19A is provided in place of the display controller 19.

The display controller 19A differs from the display controller 19 in including an image correction processing unit 19aA in place of the image correction processing unit 19a. The image correction processing unit 19aA differs from the image correction processing unit 19a in having a function to perform image correction on a depth image as a shadow map that will be described later.

The CPU 14A is similar to the CPU 14 in the hardware configuration, but differs from the CPU 14 in performing processes related to display of the virtual shadow Vs.

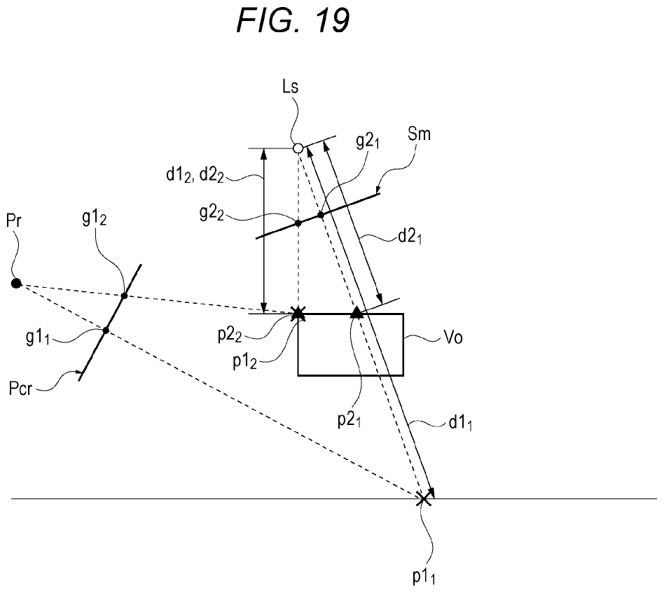

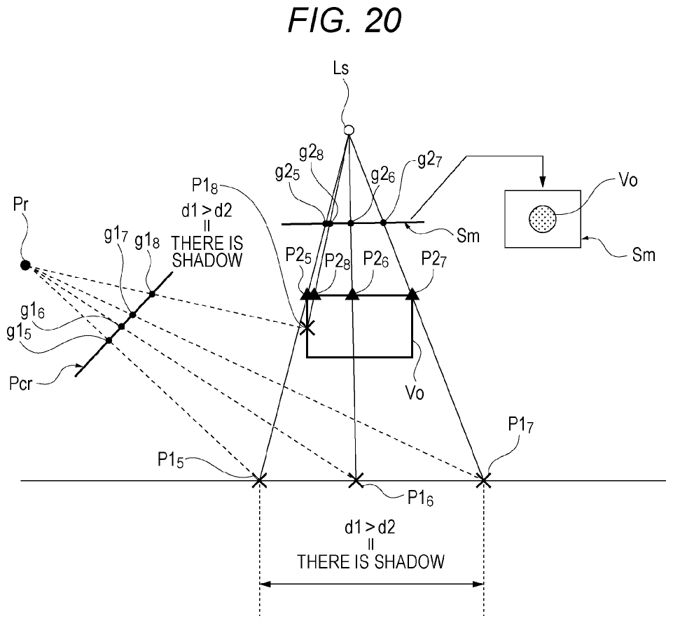

In the description below, a specific method for displaying the virtual shadow Vs will be explained with reference to FIGS. 19 and 20.

In this example, a shadow map method is used to display the virtual shadow Vs. The shadow map method is a method for drawing the virtual shadow Vs using a texture called a shadow map in which depth values supplied from the virtual light source Ls are stored.

FIG. 19 is a diagram for explaining distances d1 and distances d2 to be used according to the shadow map method.

Basically, for an image Pcr whose viewpoint is at the same position as the viewpoint (drawing viewpoint) Pr at the time of drawing a virtual object Vo, the pixels to be a shadow are specified. Hereinafter, the image Pcr will be referred to as the drawing image Pcr. Also, the pixels constituting the drawing image Pcr will be referred to as pixels g1.

By the shadow map method, to specify the pixels g1 that form the shadow in the drawing image Pcr, information about the distance d1 from each point p1 (indicated by a cross mark in the drawing) in the three-dimensional space projected onto each corresponding pixel g1 of the drawing image Pcr to the virtual light source Ls is used. In the drawing, a point p1₁ projected onto a pixel g1₁, and a point p1₂ projected on a pixel g1₂ in the drawing image Pcr are shown as examples of the points p1.

The distance from the point p1₁ to the virtual light source Ls is a distance d1₁, and the distance from the point p1₂ to the virtual light source Ls is a distance d1₂.

By the shadow map method, map information is then generated as a shadow map. The map information includes an image of the virtual object Vo viewed from the position of the virtual light source Ls, or specifically, a depth image of the virtual object Vo viewed from the virtual light source Ls as a viewpoint. Here, the depth image included in the shadow map, which is the depth image of the virtual object Vo viewed from the virtual light source Ls as a viewpoint, is referred to as the light source viewpoint image Sm. Also, the pixels constituting the light source viewpoint image Sm are referred to as pixels g2.

Further, each point (indicated by a ▴ mark in the drawing) in the three-dimensional space projected onto each corresponding pixel g2 of the light source viewpoint image Sm is referred to as a point p2. In other words, the light source viewpoint image Sm as a depth image is an image indicating the distances from the respective points p2 to the virtual light source Ls. Hereinafter, the distances from the points p2 to the virtual light source Ls will be referred to as the distances d2.

In the shadow map, for each pixel g2 of the light source viewpoint image Sm, the corresponding pixel g1 in the drawing image Pcr and the distance d1 of the pixel g1 are mapped. FIG. 19 shows that the pixel g1 corresponding to a pixel g2₁ in the light source viewpoint image Sm is the pixel g1₁, and the pixel g1 corresponding to a pixel g2₂ is the pixel g1₂.

Here, the fact that a certain pixel g1 corresponds to a certain pixel g2 means that the point p2 projected onto the pixel g2 is located on a straight line connecting the point p1 projected onto the pixel g1 and the virtual light source Ls.

By the shadow map method, the shadow map in which the pixels g1 corresponding to the respective pixels g2 of the light source viewpoint image Sm are associated with the distances d1 of the pixels g1 is used in determining whether or not each pixel g1 of the drawing image Pcr is a shadow portion.

Specifically, as for the target pixel g1, the corresponding pixel g2 in the light source viewpoint image Sm is specified. Regarding the depth value of the pixel g2, which is the distance d2, and the distance d1 of the target pixel g1, a check is made to determine whether or not “d1>d2” is satisfied, or whether or not the pixel g1 is a shadow portion.

For example, in the example shown in the drawing, as for the pixel g1₁, the pixel g2₁ of the light source viewpoint image Sm is specified as the corresponding pixel g2 from the shadow map, and the distance d1₁ (the distance d1 from the point p1₁ to the virtual light source Ls) of the pixel g1₁, and a distance d2₁ (the distance d2 from a point p2₁ to the virtual light source Ls) are specified. Because “d1₁>d2₁”, the pixel g1₁ is then determined to be a shadow portion.

On the other hand, as for the pixel g1₂, the pixel g2₂ of the light source viewpoint image Sm is specified as the corresponding pixel g2 from the shadow map, and the distance d1₂ (the distance d1 from the point p1₂ to the virtual light source Ls) of the pixel g1₂ and a distance d2₂ (the distance d2 from a point p2₂ to the virtual light source Ls) are specified. Because the relationship between those distances is “d1₂=d2₂”, the pixel g1₂ is determined not to be a shadow portion.

FIG. 20 is a diagram for explaining a shadow range.

The correspondence relationship between the pixels g1 and the pixels g2 is expressed by adding the same value as a numerical value indicated by a subscript at the end of each corresponding reference numerals.

As for the drawing image Pcr, a point p1₅ onto which a pixel g1₅ is projected is the pixel g1 corresponding to a pixel g2₅. The pixel g2₅ is the pixel g2 onto which one end portion of the upper surface of the virtual object Vo (the upper surface being the surface facing the virtual light source Ls) is projected in the light source viewpoint image Sm. Accordingly, the pixel g1₅ is determined to be a shadow portion, because the distance d1>d2.

Also, a point p1₆ onto which a pixel g1₆ is projected is the pixel g1 corresponding to a pixel g2₆ onto which the substantially central portion of the upper surface of the virtual object Vo is projected in the light source viewpoint image Sm. The pixel g1₆ is also a shadow portion, because the distance d1>d2. Further, a point p1₇ onto which a pixel g1₇ is projected is the pixel g1 corresponding to a pixel g2₇ onto which the other end portion of the upper surface of the virtual object Vo is projected in the light source viewpoint image Sm. The pixel g1₇ is also a shadow portion, because the distance d1>d2.

As can be seen from these points, in the drawing image Pcr, the range from the pixel g1₅ to the pixel g1₇ via the pixel g1₆ is the shadow portion formed by the virtual object Vo.

Also, as for the drawing image Pcr, a point p1₈ onto which a pixel g1₈ is projected is the pixel g1 corresponding to a pixel g2₈ onto which the substantially central portion of a side surface of the virtual object Vo is projected in the light source viewpoint image Sm. The pixel g1₈ is also a shadow portion, because the distance d1>d2.

Note that FIG. 20 schematically shows a state in which the light source viewpoint image Sm is viewed in plan view for confirmation. In this manner, the light source viewpoint image Sm can be expressed as an image onto which the virtual object Vo is projected.

Here, as described above, if image correction based on the latest object recognition result like the image correction for the virtual object Vo is performed on the virtual shadow image in which the virtual shadow Vs is drawn, there is a possibility that an appropriate shadow expression according to movement of the object cannot be achieved.

Therefore, this example adopts a method by which the image correction based on the latest object recognition result is performed not on the virtual shadow image but on the light source viewpoint image Sm to be used for generating the virtual shadow image by the shadow map method.

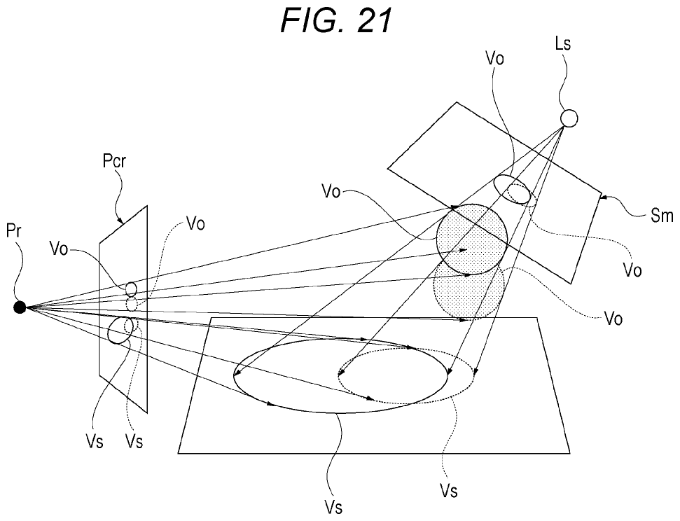

FIG. 21 is a diagram for explaining the image correction to be performed on the light source viewpoint image Sm. Specifically, FIG. 21 illustrates a method for performing image correction on the corresponding light source viewpoint image Sm in a case where a virtual object Vo moves from the position indicated by a dotted line to the position indicated by a solid line.

Here, the generation of the light source viewpoint image Sm (which is the generation of the shadow map) is performed with reference to the position of a real object Ro recognized in an object recognition process performed at a certain time point. The image correction to be performed on the light source viewpoint image Sm as explained herein is to correct the light source viewpoint image Sm generated with reference to the position of a real object Ro at a certain time point in this manner, on the basis of the position of the real object Ro recognized in an object recognition process performed at a time point later than the certain time point.

Since the virtual shadow image is an image of a shadow of the virtual object Vo, the result of recognition of the real object Ro as the reference needs to be the same between the image correction of the light source viewpoint image Sm and the image correction of the virtual object Vo, so as to achieve an appropriate shadow expression. In other words, it is necessary to perform image correction on the light source viewpoint image Sm and image correction on the virtual object Vo, using the result of recognition of the real object Ro at the same time point.

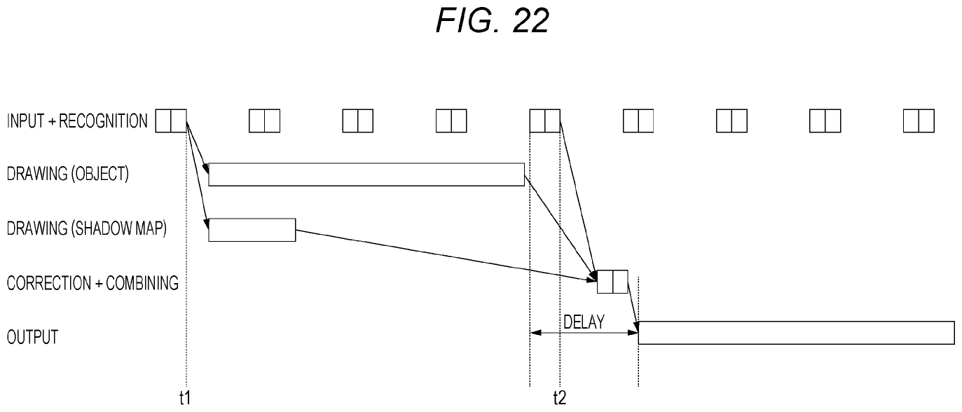

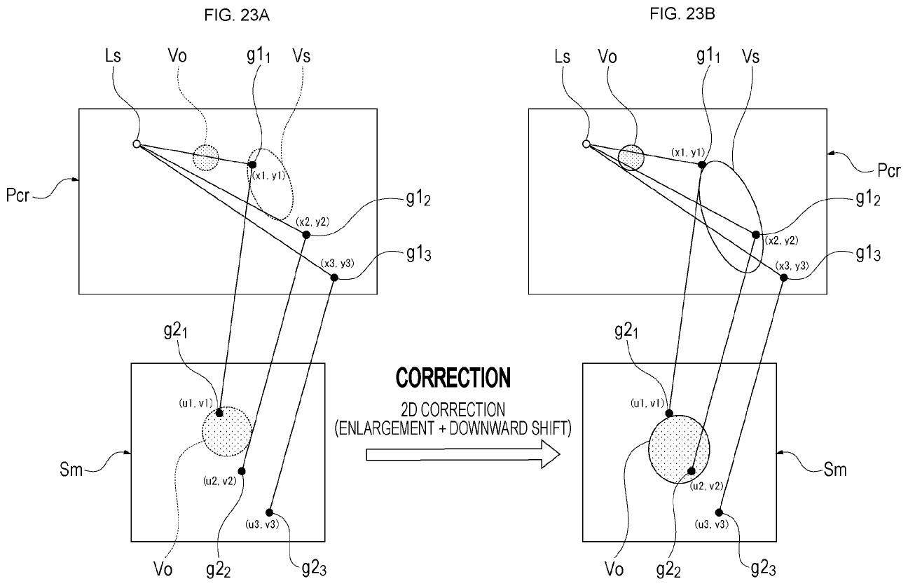

FIG. 22 is a timing chart showing a flow of processes related to the image correction of the light source viewpoint image Sm and the image correction of the virtual object Vo.

For the image correction of the virtual object Vo, a drawing process (see DRAWING (OBJECT) in the drawing) based on the result of an object recognition process performed at a certain time point indicated as a time point t1 in the drawing is performed, for example. On the basis of the result of the latest object recognition process (see time point 2 in the drawing) after the completion of the drawing process, the image correction is performed on the drawn virtual object Vo.

As for the virtual shadow image, an image of a shadow matching the position of the virtual object Vo corrected in this manner should be generated. Therefore, the image correction of the light source viewpoint image Sm uses the result of object recognition performed at the time point t2, which is the reference in the image correction of the virtual object Vo.

Specifically, in this case, the shadow map is generated on the basis of the result of the object recognition process performed at the time point t1. That is, as the light source viewpoint image Sm, an image based on the position of the real object Ro at the time point t1 is generated.

After the completion of the drawing process for the virtual object Vo, the light source viewpoint image Sm is then corrected on the basis of the result of the latest object recognition process, in response to the acquisition of the result of the latest object recognition process at the time point t2.

Note that, although the shadow map generation process in this example is performed on the basis of the result of the object recognition process performed at the time point t1, the shadow map generation process may be performed on the basis of any object recognition process result obtained before the completion of the drawing process for the virtual object Vo.

The explanation returns to FIG. 21.

As described above, the light source viewpoint image Sm is generated on the basis of the result of the object recognition process at a certain time point (the time point t1). In the drawing, the virtual object Vo at the certain time point in the light source viewpoint image Sm is indicated by a dashed line.

After the completion of the drawing process for the virtual object Vo, the moving direction, the amount of movement, and the like of the virtual object Vo from the time point t1 can be specified, in response to the acquisition of the result of the latest object recognition process at the time point t2. In accordance with the moving direction and the amount of movement of the virtual object Vo specified in this manner, the image area of the virtual object Vo in the light source viewpoint image Sm is corrected. Specifically, in the light source viewpoint image Sm in the drawing, the image area of the virtual object Vo indicated by a dotted line is corrected to be an image area indicated by a solid line.

At this point of time, the image correction of the light source viewpoint image Sm is performed as correction of the position and/or the size of the image area of the virtual object Vo.

As this example is to cope with both displacement of the virtual object Vo in the direction of the distance d2 and displacement in a direction parallel to the image plane of the light source viewpoint image Sm, both the size and the position of the image area of the virtual object Vo can be corrected in the image correction of the light source viewpoint image Sm.

In the example illustrated in the drawing, the virtual object Vo approaches the side of the virtual light source Ls in the direction of the distance d2, and is displaced to the left end side of the light source viewpoint image Sm in the direction parallel to the image plane. Therefore, in the image correction of the light source viewpoint image Sm in this case, correction is performed to increase the size of the image area of the virtual object Vo and to displace the virtual object Vo to the left side of the image.

Note that FIG. 21 schematically shows the virtual object Vo and the virtual shadow Vs projected onto the drawing image Pcr. However, in the drawing image Pcr, the virtual object Vo before the movement is also indicated by a dashed line, and the virtual object Vo after the movement is also indicated by a solid line. Further, the virtual shadow Vs generated for the virtual object Vo before the movement is indicated by a dashed line, and the virtual shadow Vs generated for the virtual object Vo after the movement is indicated by a solid line.

FIG. 23 is a diagram for explaining the relationship between the image correction of the light source viewpoint image Sm and the pixels g1 (corresponding pixels) in the drawing image Pcr mapped onto the respective pixels g2 of the light source viewpoint image Sm in the shadow map.

FIG. 23A shows an example of the drawing image Pcr and the light source viewpoint image Sm generated on the basis of the result of object recognition performed at a certain time point (the time point t1), and also shows the correspondence between the pixels g2 in the shadow map and the pixels g1. Here, the coordinates of the respective pixels g1 and g2 are also shown, with the coordinate system of the drawing image Pcr being an x-y coordinate system, the coordinate system of the light source viewpoint image Sm being a u-v coordinate system. Specifically, FIG. 23A shows pixels g2₁, g2₂, and g2₃ as an example of the pixels g2, and also shows pixels g1₁, g1₂, and g1₃ of the drawing image Pcr corresponding to these pixels g2. As shown in the drawing, the coordinates of the pixels g2₁, g2₂, and g2₃ are (u1, v1), (u2, v2), and (u3, v3), respectively, and the coordinates of the pixels g1₁, g1₂, and g1₃ are (x1, y1), (x2, y2), and (x3, y3), respectively.

FIG. 23B shows an example of the drawing image Pcr and the light source viewpoint image Sm subjected to the image correction on the basis of the object recognition result obtained at the time point t2 after the time point t1. Specifically, the image correction (2D correction) of the light source viewpoint image Sm herein is performed to enlarge the image area of the virtual object Vo and shifting the position downward in accordance with the displacement of the virtual object Vo shown as the transition from FIG. 23A to FIG. 23B. However, at this point of time, the correspondence relationship between the pixels g2 and the pixels g1 is not corrected. That is, information about the mapping with the respective pixels g1 on the side of the drawing image Pcr is maintained without any correction. The mapping information indicates that the pixel g2₁ corresponds to the pixel g1₁, the pixel g2₂ corresponds to the pixel g1₂, and the pixel g2₃ corresponds to the pixel g1₃, for example.

As described above, to shorten the display delay of the virtual shadow Vs, this example adopts a method for performing image correction on the light source viewpoint image Sm on the basis of an object recognition result. Thus, the accuracy of the expression of the virtual shadow Vs can be made higher than that in a case where image correction is performed on the virtual shadow image on the basis of an object recognition result (see FIG. 17B).

Here, in FIG. 22, the amount of the display delay of the virtual shadow Vs is indicated by a double-headed arrow denoted by “DELAY” in the drawing. However, as can be seen from this delay amount, the display delay of the virtual shadow Vs can also be shortened as in the case of the virtual object Vo.

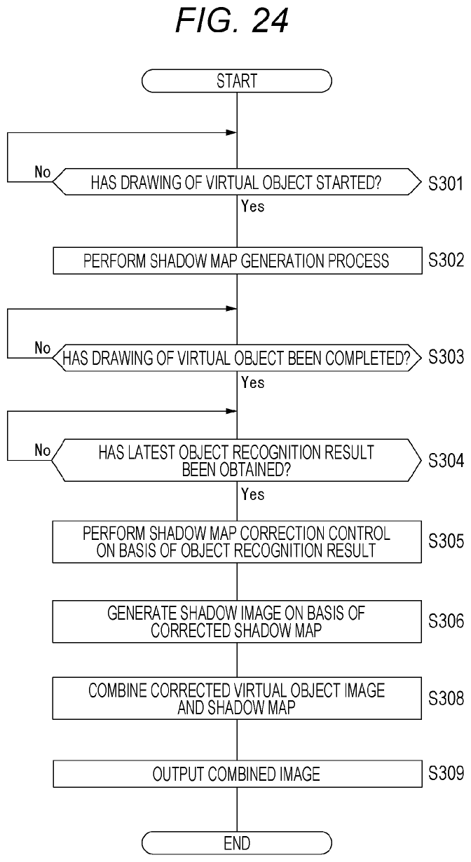

An example of specific processing procedures to be carried out to implement the shadow display method described above is now described with reference to a flowchart shown in FIG. 24.

Note that, in FIG. 24, the processing procedures to be carried out by the CPU 14A shown in FIG. 18 are shown as an example of the processing procedures.

First, in step S301, the CPU 14A waits for the start of drawing of the virtual object Vo, and performs a shadow map generation process in response to the start of drawing of the virtual object Vo. The shadow map generation process is performed with reference to the result of the same object recognition process as that used in the drawing process for the virtual object Vo whose start has been confirmed in step S301. Specifically, in the shadow map generation process, the CPU 14A generates the light source viewpoint image Sm on the basis of the result of an object recognition process, and calculates the distances d1 with respect to the respective points p1 in the three-dimensional space projected on the respective pixels g1 of the drawing image Pcr on the basis of the result of the object recognition process. In addition to this, the CPU 14A also performs a process of specifying the corresponding pixel g1 in the drawing image Pcr for each pixel g2 of the light source viewpoint image Sm, and associating the coordinate information about the corresponding pixel g1 with the distance d1 for each pixel g2. As a result, a shadow map is generated.

After the shadow map generation process performed in step S302, the CPU 14A waits until the completion of the drawing of the virtual object Vo in step S303. When the drawing of the virtual object Vo is completed, the CPU 14A moves on to step S304, and waits until the latest object recognition result is obtained.

When the latest object recognition result is obtained in step S304, the CPU 14A moves on to step S305, and performs shadow map correction control on the basis of the object recognition result. Specifically, the image correction processing unit 19aA in the display controller 19A is made to perform image correction on the light source viewpoint image Sm obtained in the shadow map generation process in step S302. At this stage, the image correction is performed to change the position and/or the size of the image area of the virtual object Vo in the light source viewpoint image Sm in accordance with the movement of the virtual object Vo (the movement from the time point t1 to the time point t2) specified from the latest object recognition result as described above. Specifically, in this example, at least both the position and the size of the image area of the virtual object Vo can be corrected as described above.

In step S306 following step S305, the CPU 14A performs a process of generating a shadow image on the basis of the corrected shadow map. That is, a virtual shadow image is generated on the basis of the shadow map including the light source viewpoint image Sm corrected by the correction control performed in step S305.

As described above, in the generation of the virtual shadow image based on the shadow map, the distance d1 of each pixel g1 in the drawing image Pcr and the distance d2 of the corresponding pixel g2 in the light source viewpoint image Sm are specified, and a check is made to determine whether or not the distance d1 and the distance d2 satisfy “d1>d2”. A shadow of each pixel g1 determined to satisfy “d1>d2” is then drawn, so that the virtual shadow image is generated.

In step S307 following step S306, the CPU 14A performs a process of combining the virtual object image after correction and the shadow image. That is, a process is performed to cause the display controller 19A to combine the drawn image of the virtual object Vo subjected to the image correction described above with reference to FIGS. 6 to 13, and the virtual shadow image generated in step S306.

In step S308 following step S307, the CPU 14A then performs a combined image output process that is a process of causing the display controller 19A to output the image combined in step S307 to the display 10.

After performing the process in step S309, the CPU 14A ends the series of processes shown in FIG. 24.

Note that, in the example described above, the size and the position of the image area of the virtual object Vo are changed in the image correction of the light source viewpoint image Sm. However, it is also conceivable that deformation, rotation, and the like may be performed, for example, in addition to changing the size (that is, scaling) and changing the position.

Furthermore, in the example described above, correction based on an object recognition result is performed as the image correction of the light source viewpoint image Sm. However, image correction based on detection signals of the sensor unit 13 that detects the viewpoint position and the line-of-sight direction of the user can also be performed.

### 8. Modifications

Here, this embodiment is not limited to the specific examples described above, and various modifications can be made. For example, in the example described above, a virtual object Vo is superimposed and displayed on a real object Ro. However, a virtual object Vo is not necessarily superimposed on a real object Ro. For example, there may be a case where a virtual object Vo is displayed so as to maintain a predetermined positional relationship with a real object Ro without overlapping. The present technology can be widely and suitably applied in a case where a virtual object Vo is associated with a real object Ro and is displayed, such as a case where a virtual object Vo is superimposed and displayed on a real object Ro, or a case where a virtual object Vo is displayed so as to maintain a predetermined positional relationship with a real object Ro.

Also, in the configuration described above as an example, the imaging unit 11 that obtains a captured image for performing object recognition, the sensor unit 13 that detects information regarding the line-of-sight position and the line-of-sight direction of the user, the display 10 that performs image display for causing the user to recognize an AR space, and the correction control unit (the CPU 14) that controls image correction of an image in which a virtual object Vo is drawn are provided in the same apparatus serving as the information processing apparatus 1. However, it is also possible to adopt a configuration in which the imaging unit 11, the sensor unit 13, and the display 10 are provided in a head-mounted device, and the correction control unit is provided in a device different from the head-mounted device.

Further, in the above explanation, a see-through HMD has been described as an example of a head-mounted display device (HMD). However, some other device such as a video see-through HMD or a retinal projection HMD can be used as a head-mounted display device.

In a case where a video see-through HMD is worn on the head or the face of the user, the video see-through HMD is worn so as to cover the eyes of the user, and a display unit such as a display is held in front of the eyes of the user. Further, the video see-through HMD includes an imaging unit for imaging a surrounding landscape, and causes the display unit to display an image of the scenery that is seen in front of the user and has been captured by the imaging unit. With such a configuration, it is difficult for the user wearing the video see-through HMD to directly view the outside scenery, but the user can check the outside scenery from the image displayed on the display unit. Furthermore, at this stage, the video see-through HMD may superimpose a virtual object on an image of the outside scenery, depending on a result of recognition of the position and/or the posture of the video see-through HMD, on the basis of an AR technology, for example.

A retinal projection HMD has a projection unit that is held in front of the eyes of the user, and an image is projected from the projection unit toward the eyes of the user so that the image is superimposed on the outside scenery. More specifically, in the retinal projection HMD, an image is projected from the projection unit directly onto the retina of the user's eye, and the image is formed on the retina. With such a configuration, even a near-sighted or far-sighted user can view a clearer video. Furthermore, the user wearing the retinal projection HMD can view the outside scenery, even while viewing the image being projected from the projection unit. With such a configuration, the retinal projection HMD can also superimpose an image of a virtual object on an optical image of a real object located in the real space, in accordance with a result of recognition of the position and/or the posture of the retinal projection HMD, on the basis of the AR technology, for example.

Further, in the example described above, the sensor unit 13 is provided as a component for estimating the viewpoint position and the line-of-sight direction of the user. However, the viewpoint position and the line-of-sight direction of the user can also be estimated by techniques described below. For example, using an imaging unit such as a camera provided therein, the information processing apparatus 1 captures an image of a marker or the like that has a known size and is presented on a real object Ro in the real space. The information processing apparatus 1 then analyzes the captured image, to estimate its own relative position and/or posture with respect to the marker (or the real object Ro on which the marker is presented). Specifically, the relative direction of the imaging unit (or the information processing apparatus 1 including the imaging unit) with respect to the marker can be estimated in accordance with the orientation of the marker (or the orientation of the pattern or the like of the marker, for example) captured in the image. Alternatively, in a case where the size of the marker is known, the distance between the marker and the imaging unit (or the information processing apparatus 1 including the imaging unit) can be estimated in accordance with the size of the marker captured in the image. More specifically, when an image of the marker is captured from a longer distance, the captured image of the marker is smaller. Also, the range in the real space captured in the image in this case can be estimated on the basis of the angle of view of the imaging unit. With the use of the above characteristics, the distance between the marker and the imaging unit can be calculated in accordance with the size of the marker captured in the image (in other words, the ratio of the marker within the angle of view). With the configuration described above, the information processing apparatus 1 can estimate its own relative position and posture with respect to the marker. That is, the viewpoint position and the line-of-sight direction of the user can be estimated.

Also, a technique called simultaneous localization and mapping (SLAM) may be used by the information processing apparatus 1 to perform self-location estimation. SLAM is a technique for estimating the self-location and creating an environmental map in parallel, using an imaging unit such as a camera, various kinds of sensors, an encoder, and the like. In a more specific example of SLAM (particularly, Visual SLAM), the three-dimensional shape of a captured scene (or the object) is sequentially restored on the basis of a moving image captured by the imaging unit. The result of the restoration of the captured scene is then associated with the result of detection of the position and the posture of the imaging unit, so that a map of the surrounding environment is created, and the position and the posture of the imaging unit (or the information processing apparatus 1) in the environment are estimated. Note that various sensors such as an acceleration sensor and an angular velocity sensor may be provided in the information processing apparatus 1, for example, so that the position and the posture of the imaging unit can be estimated as information indicating a relative change on the basis of detection results from the sensors. As long as the position and the posture of the imaging unit can be estimated, the estimation method is of course not necessarily limited to a method based on detection results from various sensors such as an acceleration sensor and an angular velocity sensor.

In the configuration described above, a relative position and posture of the information processing apparatus 1 with respect to a known marker that have been estimated on the basis of the result of imaging of the marker by the imaging unit may be used in the initialization process and the position correction according to SLAM described above, for example. Even in a situation where a marker is not included in the angle of view of the imaging unit, the information processing apparatus 1 having such a configuration can estimate its own position and posture with respect to the marker (or the real object Ro on which the marker is presented) by performing self-location estimation on the basis of SLAM taking into account the results of the initialization and the position correction performed beforehand.

In the above description, it is assumed that the line-of-sight direction of the user is estimated from the posture of the information processing apparatus 1 (a head-mounted device). However, a configuration in which the line-of-sight direction of the user is detected on the basis of a captured image or the like obtained by imaging the eyes of the user may also be adopted.

Note that the target of display delay shortening through image correction is not necessarily a virtual object Vo that is associated with a real object Ro and is displayed. For example, in an AR game or the like, position data of a virtual object Vo such as an avatar of another user as an opponent player in an AR space is received via a network, and the information processing apparatus 1 displays the virtual object Vo at the position according to the received position data. The display delay of the virtual object Vo displayed at this point of time may be shortened by image correction. The image correction in this case is not performed on the basis of a result of recognition of the real object Ro, but is performed on the basis of the amount of position change indicated by the position data received via the network.

Also, the image correction may be performed tile by tile (on a segment basis), instead of plane by plane. Further, the correction for shortening the display delay of the virtual object Vo may also be correction to be performed in the drawing process, instead of correction to be performed on a drawn image. For example, sophisticated rendering and simple rendering that can be made in real time are separated. In this case, each virtual object Vo is rendered as a billboard by the sophisticated rendering in the former stage, and only the billboards are combined by the simple rendering in the latter stage. Alternatively, the correction for shortening the display delay of the virtual object Vo may be a method for replacing it with a matrix based on the latest object recognition result immediately before the drawing to be performed by the GPU.

Further, in a case where the virtual object Vo to be superimposed on a real object Ro has an animation, the image correction processing unit 19a may be notified of information that specifies the animation. Specifically, there may be an animation in which the size and the color change depending on an object recognition result. For example, twisting or the like changes brightness. It is also possible to adopt a configuration in which such a change in the virtual object Vo is caused by image correction performed by the image correction processing unit 19a.

Further, in a case where the virtual object Vo is a human face, for example, image correction compatible with mesh deformation can also be performed. For example, in a case where an object recognition result shows a landmark of a face, and image correction is to be performed on the basis of the landmark, the image correction processing unit 19a is notified of landmark information in response to the result of rendering, and is made to perform image correction on the basis of the landmark.

### 9. Program and a Storage Medium

Although an information processing apparatus (1) as an embodiment has been described above, a program according to an embodiment is a program that causes a computer device such as a CPU to function as the information processing apparatus 1 and perform processes.

A program according to an embodiment is a program that can be read by a computer device, and causes the computer device to perform processes including: performing a first recognition process related to the position and the posture of a real object at a first time point, on the basis of a captured image including the real object; controlling a drawing processing unit to perform a first drawing process for a related virtual object associated with the real object on the basis of the first recognition process; performing a second recognition process related to the position and the posture of the real object on the basis of a captured image including the real object at a second time point that is later than the first time point; controlling the drawing processing unit to perform a second drawing process for the related virtual object associated with the real object on the basis of the second recognition process; and, before the second drawing process is completed, correcting a first image of the related virtual object obtained upon completion of the first drawing process, on the basis of a result of the second recognition process. That is, this program corresponds to the program for causing a computer device to perform the processes described above with reference to FIGS. 11 to 13 and others, for example.

Such a program can be stored beforehand into a storage medium that can be read by a computer device, such as a ROM, a solid state drive (SSD), or a hard disk drive (HDD), for example. Alternatively, the program can be temporarily or permanently saved (stored) in a removable storage medium such as a semiconductor memory, a memory card, an optical disk, a magnetooptical disk, or a magnetic disk. Such a removable storage medium can also be provided as so-called packaged software. Alternatively, such a program can be installed from a removable storage medium into a personal computer or the like, or can be downloaded into a desired information processing apparatus such as a smartphone from a download site via a network such as a local area network (LAN) or the Internet.

### 10. Summary of the Embodiments

As described above, an information processing apparatus (1 or 1A) as an embodiment includes: an image recognition processing unit (F1) that performs, on the basis of a captured image including a real object, a first recognition process related to the position and the posture of the real object at a first time point, and a second recognition process related to the position and the posture of the real object at a second time point that is later than the first time point; a drawing control unit (F2) that controls a drawing processing unit (GPU 17) to perform a first drawing process for a related virtual object associated with the real object on the basis of the first recognition process, and a second drawing process for the related virtual object associated with the real object on the basis of the second recognition process; and a correction control unit (the image correction control unit F3) that corrects a virtual object image that is an image of the related virtual object obtained upon completion of the first drawing process, on the basis of a result of the second recognition process before completion of the second drawing process.

As image correction is performed on the related virtual object on the basis of results of recognition of the position and the posture of the real object as described above, the position and the posture of the related virtual object can be changed in accordance with a change in the position and the posture of the real object in a case where such a change occurs. Further, in the configuration described above, when the latest recognition result (the recognition result of the second recognition process) is obtained, the image of the related virtual object can be instantly output as the image obtained by correcting the image that is obtained in the drawing process (the first drawing process) based on the past recognition results, without a wait for completion of the drawing process (the second drawing process) based on the latest recognition result. Accordingly, the display delay of the image of the virtual object to be displayed while being associated with the real object can be shortened. Thus, the user's feeling of strangeness can be alleviated, and the sense of immersion in the AR space can be enhanced.

Also, in the information processing apparatus as an embodiment, the correction control unit performs correction to change the position of the related virtual object in the vertical and horizontal plane in the virtual object image, on the basis of information about the position of the real object recognized in the vertical and horizontal plane by the image recognition processing unit (see FIG. 7).

With this arrangement, in a case where the real object moves in the vertical and horizontal plane, image correction can be performed to change the position of the related virtual object in the vertical and horizontal plane in accordance with the movement. Thus, a display delay with respect to the movement of the real object in the vertical and horizontal plane can be shortened.

Further, in the information processing apparatus as an embodiment, the correction control unit performs the correction to change the size of the related virtual object in the virtual object image, on the basis of the information about the position of the real object recognized in the depth direction by the image recognition processing unit.

With this arrangement, in a case where the real object moves in the depth direction, it is possible to change the size of the related virtual object in accordance with the position of the real object in the depth direction, by enlarging the image of the related virtual object when the real object approaches the viewpoint of the user, by making the image of the related virtual object smaller when the real object moves away from the viewpoint of the user, or the like, for example. Thus, a display delay with respect to the movement of the real object in the depth direction can be shortened.

Further, in the information processing apparatus as an embodiment, the correction control unit performs correction to change the position or the posture of the related virtual object in accordance with a change in the viewpoint position or the line-of-sight direction of the user.

With this arrangement, it is possible to shorten the display delay to be caused by a change in the viewpoint position and the line-of-sight direction when the user moves the head or the like. Thus, an AR system that allows movement of the user's head and line of sight can be achieved, and the sense of immersion in an AR space can be enhanced because free movement of the user's body is not restricted.

Also, in the information processing apparatus as an embodiment, in a case where one or a plurality of related virtual objects to be corrected is selected from a plurality of related virtual objects each associated with a different real object, the correction control unit preferentially selects a related virtual object associated with a real object having large movement (see step S109 in FIG. 11).

With this arrangement, it is possible to prevent image correction from being performed inadvertently on a virtual object associated with a real object having small movement or no movement. Thus, the processing load in shortening the display delay can be reduced.

Further, in the information processing apparatus as an embodiment, a processing cycle of correction is shorter than a processing cycle of the image recognition processing unit (see FIG. 14).

With this arrangement, it is possible to shorten the delay time from the point of time when a result of recognition of the real object is obtained until the image correction for the virtual object is started. Thus, the effect to shorten the display delay of the virtual object can be enhanced. Furthermore, as the processing cycles of correction are short cycles, the virtual object can be smoothly displayed.

Further, in the information processing apparatus as an embodiment, the drawing control unit controls the drawing processing unit to draw the related virtual object and a non-related virtual object in different drawing planes of a plurality of drawing planes, the non-related virtual object being a virtual object independent of the image recognition process for the real object (see FIG. 11).

With this arrangement, it is possible to perform appropriate image correction depending on whether or not the virtual object is a related virtual object, such as performing image correction on a non-related virtual object in accordance with the viewpoint position and the line-of-sight direction of the user, and performing image correction on a related virtual object in accordance with the position and the posture of the associated real object and the viewpoint position and the line-of-sight direction. Thus, the display delay of the virtual object can be appropriately shortened.

Also, in the information processing apparatus as an embodiment, in a case where the number of related virtual objects is equal to or larger than the number of drawing planes in the plurality of drawing planes, when the number of drawing planes in the plurality of drawing planes is n (n being a natural number), the drawing control unit controls the drawing processing unit to select (n−1) related virtual objects, draw the selected related virtual objects exclusively in at least one drawing plane, and draw the unselected related virtual objects and the non-related virtual objects in the remaining one drawing plane (see FIG. 11).

With this arrangement, in a case where virtual objects include a non-related virtual object for which image correction based on an object recognition result is unnecessary, and the number of related virtual objects is equal to or larger than n while the number of drawing planes is n, it is possible to perform image correction based on a result of recognition of associated real objects Ro for the (n−1) related virtual objects, and perform image correction in accordance with the viewpoint position and the line-of-sight direction of the user for the remaining related virtual objects as well as the non-related virtual objects. That is, in a case where image correction based on a result of recognition of real objects cannot be performed for all the related virtual objects because of the relationship between the number of drawing planes and the number of related virtual objects, image correction based on a result of recognition of the real objects is preferentially performed for the (n−1) related virtual objects. Thus, display delays can be appropriately shortened in accordance with the relationship between the number of drawing planes and the number of related virtual objects.

Further, in the information processing apparatus as an embodiment, the drawing control unit performs the selection, using a selection criterion by which the possibility of selection increases with increase in the amount of movement of the real object (see step S109 in FIG. 11).

With this arrangement, related virtual objects each having a large amount of movement and a high possibility of a display delay to be sensed can be preferentially selected as the targets of image correction based on a result of recognition of real objects. Thus, in a case where image correction based on a result of recognition of real objects can be performed on only some of the related virtual objects, the related virtual objects to be subjected to the image correction can be appropriately selected.

Further, in the information processing apparatus as an embodiment, the drawing control unit performs the selection, using a selection criterion by which the possibility of selection increases with decrease in the area of the real object.

In a case where a related virtual object is superimposed and displayed on a real object, when the area of the real object is large even though the amount of movement of the real object is large, the ratio of the area of the position error occurrence portion of the related virtual object to the area of the real object might be small. In such a case, any display delay is hardly sensed. On the other hand, in a case where the area of the real object is small even though the amount of movement of the real object is small, the ratio might be large, and in such a case, the display delay is easily perceived. Thus, with the configuration described above, it is possible to appropriately select a related virtual object to be subjected to the image correction based on an object recognition result, taking into consideration the ratio of the area of the position error occurrence portion of the virtual object to the area of the real object.

Also, in the information processing apparatus as an embodiment, the drawing control unit performs the selection, using a selection criterion by which the possibility of selection increases with decrease in the distance between the user's point of gaze and the real object.

With this arrangement, related virtual objects that are displayed near the user's point of gaze and have a high possibility of a display delay to be sensed can be preferentially selected as the targets of image correction based on a result of recognition of real objects. Thus, in a case where image correction based on a result of recognition of real objects can be performed on only some of the related virtual objects, the related virtual objects to be subjected to the image correction can be appropriately selected.

Further, in the information processing apparatus as an embodiment, the drawing control unit controls the drawing processing unit so that the update frequency of a drawing plane for drawing a non-related virtual object independent of the real object image recognition process among the plurality of drawing planes becomes lower than the update frequency of a drawing plane for drawing a related virtual object (see FIG. 11).

With this arrangement, drawing in all the drawing planes at a high update frequency can be prevented. Thus, it is possible to reduce the processing load and power consumption.

Further, in the information processing apparatus as an embodiment, in a case where a related virtual object is a related virtual object that has an animation, the drawing control unit controls the drawing processing unit so that the drawing update frequency of the related virtual object becomes lower than that of a related virtual object not having an animation.

With this arrangement, in a case where a plurality of drawing planes needs be used, if the related virtual object to be drawn does not have an animation, drawing of the related virtual object is performed at a low update frequency. If the related virtual object has an animation, drawing of the related virtual object is performed at a high update frequency. Thus, it is possible to reduce the processing load and power consumption by lowering the drawing update frequency of at least one drawing plane, while preventing a decrease in the reproducibility of the animation of the related virtual object.

Also, in the information processing apparatus as an embodiment, in a case where a drawing process is performed in a plurality of drawing planes, the drawing control unit controls the drawing processing unit to use at least one drawing plane smaller in size than the other drawing planes (see FIG. 15).

With this arrangement, the processing load of the drawing process can be reduced in a case where a plurality of drawing planes needs to be used. Thus, it is possible to reduce the processing load and the power consumption in shortening the display delay of a virtual object.

Further, in the information processing apparatus as an embodiment, when part of the user's body overlaps a virtual object as viewed from the viewpoint position of the user, the correction control unit performs the correction on a shielding virtual object that is a virtual object that shields the overlapping portion of the virtual object (see FIG. 16).

With this arrangement, the display delay of the shielding virtual object can be shortened. Accordingly, it is possible to alleviate the user's feeling of strangeness that is caused when the overlapping portion of a virtual object is not shielded though part of the user's body overlaps the virtual object as viewed from the viewpoint position of the user. As such feeling of strangeness is alleviated, the sense of immersion in an AR space can be enhanced.

Further, in the information processing apparatus as an embodiment, the shielding virtual object is a virtual object in the form of a hand of the user.

With this arrangement, the display delay of the shielding virtual object in the form of a hand of the user can be shortened. Accordingly, it is possible to alleviate the user's feeling of strangeness that is caused when the overlapping portion of a virtual object is not shielded though a hand of the user overlaps the virtual object as viewed from the viewpoint position of the user. As the feeling of strangeness is alleviated, the sense of immersion in the AR space can be enhanced.

Also, in the information processing apparatus as an embodiment, the drawing control unit controls the drawing processing unit to use at least one drawing plane exclusively for the shielding virtual object, the at least one drawing plane being of the plurality of drawing planes that can be used by the drawing processing unit.

With this arrangement, image correction based on an object recognition result regarding the shielding virtual object can be preferentially performed. Accordingly, it is possible to more easily alleviate the user's feeling of strangeness that may be caused by an unshielded overlapping portion between a part of the user's body and a virtual object. Thus, the sense of immersion in the AR space can be further enhanced.

The information processing apparatus as an embodiment further includes a virtual shadow image generation unit (the CPU 14A, for example) that generates, on the basis of the result of the first recognition process before completion of the first drawing process, a light source viewpoint image (Sm) that is an image of the related virtual object as viewed from the position of a virtual light source (Ls) that illuminates the related virtual object, performs control to correct the generated light source viewpoint image on the basis of the result of the second recognition process before completion of the second drawing process, and generates, on the basis of the corrected light source viewpoint image, a virtual shadow image that is an image of a virtual shadow of the related virtual object.

With this arrangement, regarding the light source viewpoint image to be used for generating a virtual shadow image, the image generated on the basis of the past recognition result (the result of the first recognition process) can be immediately corrected and used on the basis of the latest recognition result (the result of the second recognition process) even in a case where the target real object moves. Accordingly, in a case where the realistic feeling is to be increased by displaying a shadow (a virtual shadow) of the related virtual object, the display delay of the shadow can be shortened.

Thus, the user's feeling of strangeness caused by the display delay of the shadow can be alleviated, and the sense of immersion in the AR space can be enhanced.

Further, in the information processing apparatus as an embodiment, on the basis of the result of the first recognition process before completion of the first drawing process, the virtual shadow image generation unit calculates a drawing-side distance to the light source that is the distance (d1) from each point (point p1) in a three-dimensional space projected onto respective pixels (pixels g1) of a drawing image obtained by the drawing processing unit to the virtual light source. The virtual shadow image generation unit also generates the light source viewpoint image that is a depth image as a shadow map formed by a shadow map method. The virtual shadow image generation unit then performs correction on the light source viewpoint image by performing a process of changing the position or the size of the image area of the related virtual object in the shadow map on the basis of the result of the second recognition process, and generates a virtual shadow image on the basis of the corrected shadow map and the drawing-side distance to the light source.

That is, in generating the virtual shadow image by the shadow map method, correction is performed so that the position or the size of the image area of the real object in the shadow map generated on the basis of the result of the first recognition process is changed on the basis of the latest object recognition result (the result of the second recognition process).

With this arrangement, in a case where the realistic feeling is to be increased by displaying a shadow of the related virtual object, the display delay of the shadow can be shorted, and the user's feeling of strangeness caused by the display delay of the shadow is alleviated. Thus, the sense of immersion in the AR space can be enhanced.

Also, a control method as an embodiment is a control method that includes: performing a first recognition process related to the position and the posture of a real object at a first time point, on the basis of a captured image including the real object; controlling a drawing processing unit to perform a first drawing process for a related virtual object associated with the real object on the basis of the first recognition process; performing a second recognition process related to the position and the posture of the real object on the basis of a captured image including the real object at a second time point that is later than the first time point; controlling the drawing processing unit to perform a second drawing process for the related virtual object associated with the real object on the basis of the second recognition process; and, before the second drawing process is completed, correcting a first image of the related virtual object obtained upon completion of the first drawing process, on the basis of a result of the second recognition process. By such a control method as an embodiment, it is also possible to achieve functions and effects similar to those of the above-described information processing apparatus as an embodiment.

Further, a program according to an embodiment is a program that can be read by a computer device, and causes the computer device to perform processes including: performing a first recognition process related to the position and the posture of a real object at a first time point, on the basis of a captured image including the real object; controlling a drawing processing unit to perform a first drawing process for a related virtual object associated with the real object on the basis of the first recognition process; performing a second recognition process related to the position and the posture of the real object on the basis of a captured image including the real object at a second time point that is later than the first time point; controlling the drawing processing unit to perform a second drawing process for the related virtual object associated with the real object on the basis of the second recognition process; and, before the second drawing process is completed, correcting a first image of the related virtual object obtained upon completion of the first drawing process, on the basis of a result of the second recognition process. Further, a storage medium according to an embodiment is a storage medium storing the above-described program as an embodiment. With such a program and a storage medium, the above-described information processing apparatus as an embodiment can be obtained.

Note that the advantageous effects described in this specification are merely examples, and the advantageous effects of the present technology are not limited to them and may include some other effects.

### 11. Present Technology

Note that the present technology may also be embodied in the configurations described below.

(1)

An information processing apparatus including:

an image recognition processing unit that performs, on the basis of a captured image including a real object, a first recognition process related to a position and a posture of the real object at a first time point, and a second recognition process related to a position and a posture of the real object at a second time point that is later than the first time point;

a drawing control unit that controls a drawing processing unit to perform a first drawing process for a related virtual object associated with the real object on the basis of the first recognition process, and a second drawing process for the related virtual object associated with the real object on the basis of the second recognition process; and

a correction control unit that corrects a first image of the related virtual object obtained upon completion of the first drawing process, on the basis of a result of the second recognition process before completion of the second drawing process.

(2)

The information processing apparatus according to (1), in which

the correction control unit

performs correction to change a position of the related virtual object in a vertical and horizontal plane in the first image, on the basis of information about a position of the real object recognized in the vertical and horizontal plane by the image recognition processing unit.

(3)

The information processing apparatus according to (1) or (2), in which

the correction control unit

performs the correction to change a size of the related virtual object in the first image, on the basis of information about a position of the real object recognized in a depth direction by the image recognition processing unit.

(4)

The information processing apparatus according to any one of (1) to (3), in which

the correction control unit

performs the correction to change a position or a posture of the related virtual object in accordance with a change in a viewpoint position or a line-of-sight direction of the user.

(5)

The information processing apparatus according to any one of (1) to (4), in which,

when one or a plurality of related virtual objects to be subjected to the correction is selected from a plurality of related virtual objects each associated with a different real object,

the correction control unit preferentially selects a related virtual object associated with the real object having large movement.

(6)

The information processing apparatus according to any one of (1) to (5), in which

a processing cycle of the correction is shorter than a processing cycle of the image recognition processing unit.

(7) The information processing apparatus according to any one of (1) to (6), in which

the drawing control unit

controls the drawing processing unit to draw the related virtual object and a non-related virtual object in different drawing planes of a plurality of drawing planes, the non-related virtual object being a virtual object independent of an image recognition process for the real object.

(8)

The information processing apparatus according to (7), in which,

when the number of the related virtual objects is equal to or larger than the number of drawing planes in the plurality of drawing planes, and the number of drawing planes in the plurality of drawing planes is n (n being a natural number),

the drawing control unit

controls the drawing processing unit to select (n−1) of the related virtual objects, draw the selected related virtual objects exclusively in at least one drawing plane, and draw the unselected related virtual objects and the non-related virtual objects in the remaining one drawing plane.

(9)

The information processing apparatus according to (8), in which

the drawing control unit

performs the selection, using a selection criterion by which a possibility of selection increases with increase in an amount of movement of the real object.

(10)

The information processing apparatus according to (9), in which

the drawing control unit

performs the selection, using a selection criterion by which the possibility of selection increases with decrease in the area of the real object.

(11)

The information processing apparatus according to (9) or (10), in which

the drawing control unit

performs the selection, using a selection criterion by which the possibility of selection increases with decrease in a distance between a user's point of gaze and the real object.

(12)

The information processing apparatus according to any one of (1) to (11), in which

the drawing control unit

controls the drawing processing unit so that an update frequency of a drawing plane for drawing a non-related virtual object independent of an image recognition process for the real object among the plurality of drawing planes becomes lower than an update frequency of a drawing plane for drawing the related virtual object.

(13)

The information processing apparatus according to any one of (1) to (12), in which,

when the related virtual object is a related virtual object that has an animation,

the drawing control unit controls the drawing processing unit so that a drawing update frequency of the related virtual object becomes lower than a drawing update frequency of a related virtual object not having an animation.

(14)

The information processing apparatus according to any one of (1) to (13), in which,

when a drawing process is performed in a plurality of drawing planes,

the drawing control unit controls the drawing processing unit to use at least one drawing plane smaller in size than any other drawing plane.

(15)

The information processing apparatus according to any one of (1) to (14), in which,

when part of the user's body overlaps a virtual object as viewed from a viewpoint position of the user,

the correction control unit performs the correction on a shielding virtual object that is a virtual object that shields the overlapping portion of the virtual object.

(16)

The information processing apparatus according to (15), in which

the shielding virtual object is a virtual object in the form of a hand of the user.

(17)

The information processing apparatus according to (15) or (16), in which

the drawing control unit

controls the drawing processing unit to use at least one drawing plane exclusively for the shielding virtual object, the at least one drawing plane being of the plurality of drawing planes that can be used by the drawing processing unit.

(18)

The information processing apparatus according to any one of (1) to (17), further including

a virtual shadow image generation unit that generates, on the basis of a result of the first recognition process before completion of the first drawing process, a light source viewpoint image that is an image of the related virtual object as viewed from the position of a virtual light source that illuminates the related virtual object,

performs control to correct the generated light source viewpoint image on the basis of a result of the second recognition process before completion of the second drawing process, and

generates, on the basis of the corrected light source viewpoint image, a virtual shadow image that is an image of a virtual shadow of the related virtual object.

(19)

The information processing apparatus according to (18), in which,

on the basis of the result of the first recognition process before completion of the first drawing process, the virtual shadow image generation unit calculates a drawing-side distance to the light source that is a distance from each point in a three-dimensional space projected onto respective pixels of a drawing image obtained by the drawing processing unit to the virtual light source, and

the virtual shadow image generation unit generates the light source viewpoint image that is a depth image as a shadow map formed by a shadow map method,

performs correction on the light source viewpoint image by performing a process of changing the position or the size of the image area of the related virtual object in the shadow map on the basis of the result of the second recognition process, and

generates a virtual shadow image on the basis of the corrected shadow map and the drawing-side distance to the light source.

(20)

A control method including:

performing a first recognition process related to a position and a posture of a real object at a first time point, on the basis of a captured image including the real object;

controlling a drawing processing unit to perform a first drawing process for a related virtual object associated with the real object on the basis of the first recognition process;

performing a second recognition process related to a position and a posture of the real object on the basis of a captured image including the real object at a second time point that is later than the first time point;

controlling the drawing processing unit to perform a second drawing process for the related virtual object associated with the real object on the basis of the second recognition process; and

before the second drawing process is completed, correcting a first image of the related virtual object obtained upon completion of the first drawing process, on the basis of a result of the second recognition process.

(21)

A storage medium storing a program that can be read by a computer device, the program causing the computer device to perform a process including:

performing a first recognition process related to a position and a posture of a real object at a first time point, on the basis of a captured image including the real object;

controlling a drawing processing unit to perform a first drawing process for a related virtual object associated with the real object on the basis of the first recognition process;

performing a second recognition process related to a position and a posture of the real object on the basis of a captured image including the real object at a second time point that is later than the first time point;

controlling the drawing processing unit to perform a second drawing process for the related virtual object associated with the real object on the basis of the second recognition process; and

before the second drawing process is completed, correcting a first image of the related virtual object obtained upon completion of the first drawing process, on the basis of a result of the second recognition process.

### REFERENCE SIGNS LIST

1, 1A Information processing apparatus
10 Output unit
11 Imaging unit
11a First imaging unit
11b Second imaging unit
12 Operating unit
13 Sensor unit
14, 14A CPU
15 ROM
16 RAM
17 GPU
18 Image memory
18a Buffer
19, 19A display controller
19a, 19aA Image correction processing unit
20 Recording/reproduction control unit
21 Communication unit
22 Bus
100a, 100b Lens
101 Holding unit
F1 Image recognition processing unit
F2 Drawing control unit
F3 Image correction control unit
50 AR system
Ro (Ro1, Ro2, Ro3) Real object
Vo (Vo2, Vo3) Virtual object
Ls Virtual light source
Vs Virtual shadow
Pr Viewpoint (drawing viewpoint)
Pcr Drawing image
g1, g2 Pixel
Sm Light source viewpoint image

1. An information processing apparatus comprising:
an image recognition processing unit that performs, on a basis of a captured image including a real object, a first recognition process related to a position and a posture of the real object at a first time point, and a second recognition process related to a position and a posture of the real object at a second time point that is later than the first time point;
a drawing control unit that controls a drawing processing unit to perform a first drawing process for a related virtual object associated with the real object on a basis of the first recognition process, and a second drawing process for the related virtual object associated with the real object on a basis of the second recognition process; and
a correction control unit that corrects a virtual object image that is an image of the related virtual object obtained upon completion of the first drawing process, on a basis of a result of the second recognition process before completion of the second drawing process.

2. The information processing apparatus according to claim 1, wherein
the correction control unit
performs correction to change a position of the related virtual object in a vertical and horizontal plane in the virtual object image, on a basis of information about a position of the real object recognized in the vertical and horizontal plane by the image recognition processing unit.

3. The information processing apparatus according to claim 1, wherein
the correction control unit
performs the correction to change a size of the related virtual object in the virtual object image, on a basis of information about a position of the real object recognized in a depth direction by the image recognition processing unit.

4. The information processing apparatus according to claim 1, wherein
the correction control unit
performs the correction to change a position or a posture of the related virtual object in accordance with a change in a viewpoint position or a line-of-sight direction of a user.

5. The information processing apparatus according to claim 1, wherein,
when one or a plurality of related virtual objects to be subjected to the correction is selected from a plurality of related virtual objects each associated with a different real object,
the correction control unit preferentially selects a related virtual object associated with the real object having large movement.

6. The information processing apparatus according to claim 1, wherein
a processing cycle of the correction is shorter than a processing cycle of the image recognition processing unit.

7. The information processing apparatus according to claim 1, wherein
the drawing control unit
controls the drawing processing unit to draw the related virtual object and a non-related virtual object in different drawing planes of a plurality of drawing planes, the non-related virtual object being a virtual object independent of an image recognition process for the real object.

8. The information processing apparatus according to claim 7, wherein,
when the number of the related virtual objects is equal to or larger than the number of drawing planes in the plurality of drawing planes, and the number of drawing planes in the plurality of drawing planes is n (n being a natural number),
the drawing control unit
controls the drawing processing unit to select (n−1) of the related virtual objects, draw the selected related virtual objects exclusively in at least one drawing plane, and draw the unselected related virtual objects and the non-related virtual objects in a remaining one drawing plane.

9. The information processing apparatus according to claim 8, wherein
the drawing control unit
performs the selection, using a selection criterion by which a possibility of selection increases with increase in an amount of movement of the real object.

10. The information processing apparatus according to claim 9, wherein
the drawing control unit
performs the selection, using a selection criterion by which the possibility of selection increases with decrease in area of the real object.

11. The information processing apparatus according to claim 9, wherein
the drawing control unit
performs the selection, using a selection criterion by which the possibility of selection increases with decrease in a distance between a user's point of gaze and the real object.

12. The information processing apparatus according to claim 1, wherein
the drawing control unit
controls the drawing processing unit so that an update frequency of a drawing plane for drawing a non-related virtual object independent of an image recognition process for the real object among a plurality of drawing planes becomes lower than an update frequency of a drawing plane for drawing the related virtual object.

13. The information processing apparatus according to claim 1, wherein,
when the related virtual object is a related virtual object that has an animation,
the drawing control unit controls the drawing processing unit so that a drawing update frequency of the related virtual object becomes lower than a drawing update frequency of a related virtual object not having an animation.

14. The information processing apparatus according to claim 1, wherein,
when a drawing process is performed in a plurality of drawing planes,
the drawing control unit controls the drawing processing unit to use at least one drawing plane smaller in size than any other drawing plane.

15. The information processing apparatus according to claim 1, wherein,
when part of a user's body overlaps a virtual object as viewed from a viewpoint position of the user,
the correction control unit performs the correction on a shielding virtual object that is a virtual object that shields the overlapping portion of the virtual object.

16. The information processing apparatus according to claim 15, wherein
the shielding virtual object is a virtual object in a form of a hand of the user.

17. The information processing apparatus according to claim 15, wherein
the drawing control unit
controls the drawing processing unit to use at least one drawing plane exclusively for the shielding virtual object, the at least one drawing plane being of the plurality of drawing planes that can be used by the drawing processing unit.

18. The information processing apparatus according to claim 1, further comprising
a virtual shadow image generation unit that generates, on a basis of a result of the first recognition process before completion of the first drawing process, a light source viewpoint image that is an image of the related virtual object as viewed from a position of a virtual light source that illuminates the related virtual object,
performs control to correct the generated light source viewpoint image on a basis of a result of the second recognition process before completion of the second drawing process, and
generates, on a basis of the corrected light source viewpoint image, a virtual shadow image that is an image of a virtual shadow of the related virtual object.

19. The information processing apparatus according to claim 18, wherein,
on a basis of the result of the first recognition process before completion of the first drawing process, the virtual shadow image generation unit calculates a drawing-side distance to a light source that is a distance from each point in a three-dimensional space projected onto respective pixels of a drawing image obtained by the drawing processing unit to the virtual light source, and
the virtual shadow image generation unit generates the light source viewpoint image that is a depth image as a shadow map formed by a shadow map method,
performs correction on the light source viewpoint image by performing a process of changing a position or a size of an image area of the related virtual object in the shadow map on a basis of the result of the second recognition process, and
generates the virtual shadow image on a basis of the corrected shadow map and the drawing-side distance to the light source.

20. A control method comprising:
performing a first recognition process related to a position and a posture of a real object at a first time point, on a basis of a captured image including the real object;
controlling a drawing processing unit to perform a first drawing process for a related virtual object associated with the real object on a basis of the first recognition process;
performing a second recognition process related to a position and a posture of the real object on a basis of a captured image including the real object at a second time point that is later than the first time point;
controlling the drawing processing unit to perform a second drawing process for the related virtual object associated with the real object on a basis of the second recognition process; and
before the second drawing process is completed, correcting a first image of the related virtual object obtained upon completion of the first drawing process, on a basis of a result of the second recognition process.
